(19) United States
(12) Patent Application Publication
(10) Pub. No.: US 2006/0183449 A1
(43) Pub. Date: Aug. 17, 2006

(54) Gain variable voltage/current conversion circuit and filter circuit using the same

(76) Inventor: Shinichi Hori, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/542,576

(22) PCT Filed: Jan. 16, 2004
(86) PCT No.: PCT/JP04/00337

§ 371 Date: Jul. 19, 2005

(30) Foreign Application Priority Data
Jan. 20, 2003 (JP) 2003-010533

(51) Int. Cl. H04B 17/00

(52) U.S. Cl. 455/226.2

(57) ABSTRACT

The present invention provides a voltage-current converting circuit which is capable of varying a gain in a wide range without a switching circuit by applying a control voltage to a single control terminal. The voltage-current converting circuit is comprised of a parallel circuit including positive resistors R1 and R2, and transistors Q3 and Q4 each acting as a negative resistor, and electrically connected in parallel with the positive resistors R1 and R2, and transistors Q1 and Q2 each carrying out voltage-current conversion and electrically connected in series to the parallel circuit. A variable voltage source VV is electrically connected between the transistors Q3, Q4 and a ground. By controlling a voltage of the variable voltage source VV, resistances of the transistors Q3 and Q4 are controlled. By varying a voltage of the variable voltage source VV, resistances of the transistors Q3 and Q4 vary, resulting in that a voltage between a gate and a source in the transistors Q1 and Q2 varies, and thus, a mutual conductance gm of the voltage-current converting circuit varies.

### FIELD OF THE INVENTION

The invention relates to a voltage-current conversion circuit (gm amplifier) having a variable conversion gain, and further to a filtering circuit including a combination circuit comprised of the voltage-current conversion circuit and a capacity device.

### PRIOR ART

In recent years, there is a need for a receiver (multi-mode receiver) designed to operate in a plurality of wireless communication systems.

Such a receiver is required to include a filtering circuit (multi-mode filter) for selecting a channel in accordance with each of wireless communication systems. The filtering circuit is required to have a function of varying a pass band width in a wide range.

In general, if a receiver is comprised of one chip, there would be selected gm-C system in which a channel-selecting filtering circuit is comprised of a voltage-current conversion circuit (a gm amplifier) and a capacity device. In order for the channel-selecting filtering circuit to have a function of varying a pass band width, the voltage-current conversion circuit is necessary to have a function of varying a conversion gain in a wide range.

A voltage-current conversion circuit (a gm amplifier) is comprised generally of a bipolar transistor, a MOSFET transistor, or other active devices. A voltage-current conversion circuit is actually designed to have a mutual conductance (gm value) which is electrically controllable relative to a designed conductance within ±30%, in order to absorb variance in a process. In order to control a mutual conductance beyond ±30%, there is generally used a switching circuit.

As an example of a voltage-current conversion circuit including a switching circuit, a MOS type gm amplifier having linearity enhanced by source degeneration process and further having a widely variable gain is suggested in IEEE, JSSC. Vol. 35, No. 4, pp. 476-489 (April 2000). FIG. 23 is a circuit diagram of the suggested MOS type gm amplifier.

The MOS type gm amplifier illustrated in FIG. 23 is comprised of n-type MOSFET transistors Q21 and Q22 each carrying out voltage-current conversion, positive resistors R21, R23 and R25 all electrically connected in series between a source of the n-type MOSFET transistor Q21 and a grounded voltage, positive resistors R22, R24 and R26 all electrically connected in series between a source of the n-type MOSFET transistor Q22 and a grounded voltage, a switching circuit SW1 electrically connected between a connection node at which the positive resistors R21 and R23 are electrically connected to each other and a connection node at which the positive resistors R22 and R24 are electrically connected to each other, and a switching circuit SW2 electrically connected between a connection node at which the positive resistors R23 and R25 are electrically connected to each other and a connection node at which the positive resistors R24 and R26 are electrically connected to each other.

In an operation of the MOS type gm amplifier illustrated in FIG. 23, when an input voltage signal Vin+ is input into a gate of the n-type MOSFET transistor Q21, there is obtained an output current Iout+, and when an input voltage signal Vin− is input into a gate of the n-type MOSFET transistor Q22, there is obtained an output current Iout−.

FIG. 24 is a circuit diagram of a source degeneration type gm amplifier.

The source degeneration type gm amplifier illustrated in FIG. 24 is comprised of a n-type MOSFET transistor Q21 carrying out voltage-current conversion, and a positive resistor R21 electrically connected at one end to a source of the n-type MOSFET transistor Q21, and at the other end grounded.

In an operation of the source degeneration type gm amplifier illustrated in FIG. 24, when an input voltage signal Vin is input into a gate of the n-type MOSFET transistor Q21, there is obtained an output current Iout.

The MOS type gm amplifier illustrated in FIG. 23 is equivalent to a differential version of the source degeneration type gm amplifier illustrated in FIG. 24.

Specifically, the MOS type gm amplifier illustrated in FIG. 23 is equivalent to an amplifier in which the n-type MOSFET transistor Q21 of the source degeneration type gm amplifier illustrated in FIG. 24 is replaced with a pair of the n-type MOSFET transistors Q21 and Q22, the positive resistor R21 is replaced with the positive resistors R21, R23 and R25 and the positive resistors R22, R24 and R26, and the corresponding differential pairs are electrically connected to each other through the switching circuits SW1 and SW2.

A mutual conductance Gm (Gm=Iout/Vin) in the source degeneration type gm amplifier illustrated in FIG. 24 is expressed with the following equation (1) wherein gm₀ indicates a mutual conductance of the n-type MOSFET transistor Q21, and R indicates a resistance of the positive resistor R21.
Gm=gm₀/(1+gm₀·R) (1)

The equation (1) indicates that a mutual conductance Gm can be controlled by varying a resistance of the positive resistor R21.

In the MOS type gm amplifier illustrated in FIG. 23, when the switching circuits SW1 and SW2 are off, a resistance between sources of the n-type MOSFET transistors Q21 and Q22 and a ground is equal to a sum of resistances of the positive resistors R21, R23 and R25 or a sum of resistances of the positive resistors R22, R24 and R26.

In contrast, when the switching circuit SW1 is on, since the MOS type gm amplifier illustrated in FIG. 23 is a differential circuit, it can be said that a node including the switching circuit SW1 is grounded in an AC manner. Accordingly, it can be said that only the positive resistor R21 or R22 is electrically connected in an AC manner between a source of the n-type MOSFET transistor Q21 or Q22 and a ground.

That is, the resistance R in the equation (1) is equal to a sum of the resistances of the resistors R21, R23 and R25 (or a sum of the resistances of the resistors R22, R24 and R26) when the switching circuits SW1 and SW2 are off, and is equal to the resistance of the resistor R21 (or the resistance of the resistor R22) when the switching circuit SW1 is on.

If the resistances of the resistors R21 to R26 are equal to one another, and the mutual conductance gm₀ of the n-type MOSFET transistor Q21 is equal to 1/(the resistance of the resistor R21), the MOS type gm amplifier illustrated in FIG. 23 would have a double-variable mutual conductance Gm.

The MOS type gm amplifier illustrated in FIG. 23 is characterized in that since bias voltages remain unchanged at nodes, even if the switching circuits SW1 and SW2 are turned on or off to change current paths, the mutual conductance gm₀ in the equation (1) can be treated as a fixed conductance, and accordingly, a mutual conductance Gm can be varied only by controlling the resistances of the resistors.

FIG. 25 is a circuit diagram of a MOS type gm amplifier as second prior art, disclosed in IEEE. JSSC. Vol. 37, No. 2, pp. 125-136, February 2002. FIG. 25(a) is a circuit diagram of the entirety, and FIG. 25(b) is a circuit diagram of the programmable current mirror circuits G1 and G2 found in FIG. 25(a).

The MOS type gm amplifier illustrated in FIG. 25(a) is comprised of p-type MOSFET transistors Q23, Q24, Q25 and Q26, current sources CS1, CS2 and CS3, a voltage source VS, and programmable current mirror circuits G1 and G2.

The current source CS1 is electrically connected to the voltage source VS and drains of the p-type MOSFET transistors Q23 and Q26. The voltage source VS is electrically connected to drains of the p-type MOSFET transistors Q24 and Q25. The p-type MOSFET transistors Q23 and Q25 are electrically connected through sources thereof to the programmable current mirror circuit G1, and the p-type MOSFET transistors Q24 and Q26 are electrically connected through sources thereof to the programmable current mirror circuit G2. The current source CS2 is electrically connected to the programmable current mirror circuit G1, and the current source CS3 is electrically connected to the programmable current mirror circuit G2. The p-type MOSFET transistors Q23 and Q24 receive an input voltage signal Vin+ through gates thereof, and the p-type MOSFET transistors Q25 and Q26 receive an input voltage signal Vin− through gates thereof.

Each of the programmable current mirror circuits G1 and G2 illustrated in FIG. 25(b) is comprised of n-type MOSFET transistors Q27, Q28, Q29, Q30, Q31, Q32, Q33, Q34, Q35 and Q36, and switching circuits SW3, SW4 and SW5 electrically connected to gates of the n-type MOSFET transistors Q31, Q32, and Q33.

The programmable current mirror circuits G1 and G2 are designed to have such a structure that the n-type MOSFET transistors Q31, Q32 and Q33 through which a current output from the MOS type gm amplifier runs are arranged in parallel, and a MOSFET transistor which actually operates can be selected among the n-type MOSFET transistors Q31, Q32 and Q33 by means of the switching circuits SW3, SW4 and SW5.

On entry of differential input voltage signals Vin+ and Vin− into gates of the p-MOSFET transistors Q23, Q24 and Q25, Q26, respectively, a current having differential components associated with the differential input voltage runs into the programmable current mirror circuits G1 and G2 through the MOSFET transistors Q23, Q24, Q25 and Q26. By turning on or off the switching circuits SW3 to SW5, the differential components are amplified by desired times, and a desired current is output from the programmable current mirror circuits G1 and G2.

In a condition illustrated in FIG. 25, since the switching circuits SW3 and SW4 in the programmable current mirror circuits G1 and G2 have a path to the voltage source, the n-type MOSFET transistors Q31 and Q32 are on. In order to reduce the mutual conductance Gm, a path of the switching circuit SW4 is turned to a ground. As a result, the n-type MOSFET transistor Q32 is turned off, and thus, the mutual conductance Gm is reduced. In order to increase the mutual conductance Gm, a path of the switching circuit SW5 is turned to the voltage source. As a result, the n-type MOSFET transistor Q33 is turned on, and thus, the mutual conductance Gm is increased.

The programmable current mirror circuits G1 and G2 illustrated in FIG. 25(b) are characterized in that since the switching circuits SW3, SW4 and SW5 are electrically connected at one ends thereof to gates of the n-type MOSFET transistors Q31, Q32 and Q33, respectively, the circuits G1 and G2 are less influenced by parasitic factors (resistance, capacity, and so on) of the switching circuits SW3, SW4 and SW5.

The greater the number of MOSFET transistors arranged in parallel is, the greater a variable range of the mutual conductance Gm is.

The above-mentioned prior art was necessary to have a switching circuit(s) in order to widen a variable range of a gain of a voltage-current converting circuit (gm amplifier). Hence, the prior art was necessary to include a digital circuit, resulting in that a circuit structure was unavoidably complex, and an area of a chip was unavoidably increased.

The first prior art circuit illustrated in FIG. 23 is accompanied with a problem that since a current runs through the switching circuits SW1 and SW2, the circuit is much influenced by a parasitic impedance of the switching circuits SW1 and SW2.

The second prior art circuit illustrated in FIG. 25 is accompanied with a problem that a lot of MOSFET transistors acting as a current source have to be arranged in parallel for ensuring a wide variable range of a gain, and if only a minimum number of MOSFET transistors operate, a capacity of the rest of MOSFET transistors, that is, non-operating MOSFET transistors causes harmful influences. Hence, when a filter having a variable pass band is comprised of the voltage-current converting circuit (gm amplifier) of the second prior art, the filter unavoidably has to have a complex structure, and a chip is unavoidably large in size.

Japanese Patent Application Publication No. 3-64109 has suggested a differentially amplifying circuit including a pair of MOSFET transistors for increasing a mutual conductance of differentially amplifying stages. Source electrodes of the pair of MOSFET transistors are electrically connected to each other through nodes, and active devices are electrically connected between the source electrodes and the nodes. Thus, a function of a negative resistance device is accomplished.

Japanese Patent Application Publication No. 7-235840 has suggested an amplifying circuit having a variable gain, comprised of a first pair of transistors receiving an input through bases thereof, a PN junction pair receiving a collector current from each of the first pair of transistors, as a bias current, a second pair of transistors including a current provider which provides a current to a common emitter receiving a voltage difference in the PN junction pair as an input through a base thereof, and a third pair of transistors including a current provider having collector current paths electrically connected to emitters of the first pair of transistors, and bases electrically connected to the collector current paths, the emitters being electrically connected to each other through an impedance, the current provider providing a bias current to the emitters. A collector of the second pair of transistors provides an output.

Japanese Patent Application Publication No. 2001-36356 has suggested a voltage-current converting circuit comprised of a first circuit including a MOS transistor differential pair, a second circuit including a MOS transistor differential pair having drain terminals electrically connected to source terminals of the first circuit, and a resistor electrically connected between sources of the second circuit. Gate terminals of the first circuit act as an input voltage terminal, and drain terminals of the first circuit act as an output current terminal. Each of gates of two MOS transistors complementary to each other in the second circuit is electrically connected to a drain of the other MOS transistor, and sources of the two MOS transistors are grounded through a current source.

However, the above-mentioned problems remain unsolved even in the circuits suggested in the above-mentioned Publications.

In view of the above-mentioned problems in the prior art, a first object of the present invention is to provide a voltage-current converting circuit which is capable of varying a gain in a wide range without a switching circuit, a second object of the present invention is to simplify a circuit structure to thereby reduce an area of a chip, and a third object of the present invention is to accomplish a filter having a highly variable range of a pass band, with the simplified circuit structure for accomplishing a multi-mode receiver having a small area of a chip.

### DISCLOSURE OF THE INVENTION

In order to accomplish the above-mentioned objects, the present invention provides a voltage-current converting circuit which outputs a current in accordance with a voltage input thereto, including an active device having an input terminal, an output terminal, and a grounded terminal, and carrying out voltage-current conversion, and a resistor circuit electrically connected in series to the active device through the grounded terminal of the active device, and controlling a conversion gain of the active device, the resistor circuit having a variable resistance, and including a negative resistance device.

In the voltage-current converting circuit in accordance with the present invention, the active device carrying out voltage-current conversion is electrically connected in series to the resistor circuit including a negative resistance device and having a variable resistance. For instance, by designing the negative resistance device to have a variable resistance, it would be possible to much vary a resistance of the resistor circuit. Hence, it would be possible for the active device to have a broad variable range of a voltage-current conversion gain. For instance, the negative resistance device may be comprised of a MOSFET transistor or a bipolar transistor. Accordingly, since it is possible to control the resistance by a single control signal, that is, by applying a control voltage to a single control terminal, the voltage-current conversion circuit can be compactly formed of a small number of circuit elements without necessity of using a switching circuit. In addition, a combination of the voltage-current converting circuit and a capacity device could present a filter having a simple circuit structure, but having a broad variable range of a pass band.

In the voltage-current converting circuit in accordance with the present invention, the active device may be comprised of a pair of active devices each operating differentially with each other, and each having an input terminal, an output terminal, and a grounded terminal, and carrying out voltage-current conversion, and the resistor circuit may be comprised of a pair of resistor circuits each electrically connected in series to each of the active devices through the grounded terminal of each of the active devices, and each controlling a conversion gain of each of the active devices, each of the resistor circuits having a variable resistance, and including a negative resistance device.

It is preferable that the negative resistance device has a variable resistance.

The resistor circuit may be designed to have various structures, as mentioned below.

For instance, the resistor circuit or each of the resistor circuits may be comprised of one or a plurality of resistance device(s) electrically connected in series to the active device, and a negative resistance device electrically connected in parallel with at least one of the resistance device(s).

The resistor circuit or each of the resistor circuits may be comprised of a first circuit comprised of a resistance device and a negative resistance device electrically connected in series to each other, the first circuit being electrically connected in series to the active device.

The resistor circuit or each of the resistor circuits may be comprised of a first resistance device electrically connected in series to the active device, and a second circuit electrically connected in parallel with the first resistance device, the second circuit being comprised of a negative resistance device, and a second resistance device electrically connected in series to the negative resistance device.

It is preferable that the negative resistance device of the pair of resistance circuits is comprised of a pair of active devices electrically connected in cross to each other and operating differentially with each other, and each receiving, as an input signal, a node signal either at a connection node at which the active device and the resistor circuit are electrically connected to each other or at any connection node in the resistor circuit.

For instance, the negative resistance device is comprised of a field effect transistor or a bipolar transistor.

A resistance of the negative resistance device may be controlled by controlling either a source voltage or an emitter voltage of the field effect transistor or bipolar transistor.

It is preferable that the voltage-current converting circuit in accordance with the present invention further includes a voltage-providing circuit electrically connected between a reference voltage point and either a source or an emitter of the field effect transistor or bipolar transistor, and wherein a resistance of the negative resistance device is controlled by controlling a voltage provided by the voltage-providing circuit.

For instance, the voltage-providing circuit may be comprised of an operational amplifier having a first input terminal, a second input terminal, and an output terminal, and an active device. A voltage-control signal is input to the first input signal of the operational amplifier, an input terminal of the active device is electrically connected to the output terminal of the operational amplifier, and an output terminal of the active device is electrically connected to the second input terminal of the operational amplifier.

It is preferable that the negative resistance device is comprised of a pair of field effect transistors or bipolar transistors operating differentially with each other, wherein sources or emitters of the field effect transistors or bipolar transistors are electrically connected to each other.

The voltage-current converting circuit in accordance with the present invention may further include a voltage-controller electrically connected to a connection node at which the active device and the resistor circuit are electrically connected to each other, for controlling a voltage of the connection node.

The voltage-controller may be comprised of an active device electrically connected between a reference voltage and the connection node, and having an input terminal to which a bias signal is input.

For instance, the voltage-controller may be designed to compensate for voltage fluctuation caused at the connection node by variance of a resistance of the negative resistance device.

The resistor circuit may be designed to include a variable resistor having a positive resistance.

The variable resistor may be comprised of an active device.

The active device may be comprised of a field effect transistor or a bipolar transistor.

The active device carrying out voltage-current conversion and the active device comprising the negative resistance device may be comprised of the same transistors having electrical conductivities different from each other.

The present invention further provides a filtering circuit including a combination circuit comprised of a voltage-current converting circuit, and a capacity device. As the voltage-current converting circuit is used the above-mentioned voltage-current converting circuit, ensuring that a pass band can be controlled by varying a gain of the voltage-current converting circuit.

### BRIEF DESCRIPTION OF THE DRAWINGS

FIG. 1(a) is a circuit diagram of a voltage-current converting circuit in accordance with the first embodiment of the present invention, and FIG. 1(b) is used for explanation of an operation of the voltage-current converting circuit.

FIG. 2(a) is a circuit diagram of a variant of a voltage-current converting circuit in accordance with the first embodiment of the present invention, and FIG. 2(b) is used for explanation of an operation of the variant.

FIG. 3(a) is a circuit diagram of a voltage-current converting circuit in accordance with the second embodiment of the present invention, and FIG. 3(b) is used for explanation of an operation of the voltage-current converting circuit.

FIG. 4(a) is a circuit diagram of a voltage-current converting circuit in accordance with the third embodiment of the present invention, and FIG. 4(b) is used for explanation of an operation of the voltage-current converting circuit.

FIG. 5(a) is a circuit diagram of a voltage-current converting circuit in accordance with the fourth embodiment of the present invention, and FIG. 5(b) is used for explanation of an operation of the voltage-current converting circuit.

FIG. 6(a) is a circuit diagram of a voltage-current converting circuit in accordance with the fifth embodiment of the present invention, and FIG. 6(b) is used for explanation of an operation of the voltage-current converting circuit.

FIG. 7 is a circuit diagram of an example of the variable voltage source in the fifth embodiment of the present invention.

FIG. 8(a) is a circuit diagram of a voltage-current converting circuit in accordance with the sixth embodiment of the present invention, and FIG. 8(b) is used for explanation of an operation of the voltage-current converting circuit.

FIG. 9 is a circuit diagram of an example of the bias circuit in the sixth embodiment of the present invention.

FIG. 10(a) is a circuit diagram of a voltage-current converting circuit in accordance with the seventh embodiment of the present invention, and FIG. 10(b) is used for explanation of an operation of the voltage-current converting circuit.

FIG. 11(a) is a circuit diagram of a voltage-current converting circuit in accordance with the eighth embodiment of the present invention, and FIG. 11(b) is used for explanation of an operation of the voltage-current converting circuit.

FIG. 12(a) is a circuit diagram of a voltage-current converting circuit in accordance with the ninth embodiment of the present invention, and FIG. 12(b) is used for explanation of an operation of the voltage-current converting circuit.

FIG. 13 is a circuit diagram of an example of the phase-inverting circuit in the ninth embodiment of the present invention.

FIG. 14(a) is a circuit diagram of a voltage-current converting circuit in accordance with the tenth embodiment of the present invention, and FIG. 14(b) is used for explanation of an operation of the voltage-current converting circuit.

FIG. 15 is a circuit diagram of a first example of the variable positive resistor in the tenth embodiment of the present invention.

FIG. 16 is a circuit diagram of a second example of the variable positive resistor in the tenth embodiment of the present invention.

FIG. 17(a) is a circuit diagram of a voltage-current converting circuit in accordance with the eleventh embodiment of the present invention, and FIG. 17(b) is used for explanation of an operation of the voltage-current converting circuit.

FIG. 18(a) is a circuit diagram of a voltage-current converting circuit in accordance with the twelfth embodiment of the present invention, and FIG. 18(b) is used for explanation of an operation of the voltage-current converting circuit.

FIG. 19(a) is a circuit diagram of a voltage-current converting circuit in accordance with the thirteenth embodiment of the present invention, and FIG. 19(b) is used for explanation of an operation of the voltage-current converting circuit.

FIG. 20(a) is a circuit diagram of a voltage-current converting circuit in accordance with the fourteenth embodiment of the present invention, and FIG. 20(b) is used for explanation of an operation of the voltage-current converting circuit.

FIG. 21(a) is a circuit diagram of a filter circuit in accordance with the fifteenth embodiment of the present invention, and FIG. 21(b) is a circuit diagram of the voltage-current converting circuit used in the filter circuit.

FIG. 22 is used for explanation of an operation of the filter circuit in accordance with the fifteenth embodiment of the present invention.

FIG. 23 is a circuit diagram of the MOS type gm amplifier as the first prior art.

FIG. 24 is a circuit diagram of the source degeneration type gm amplifier.

FIG. 25(a) is a circuit diagram of the MOS type gm amplifier as the second prior art, and FIG. 25(b) is a circuit diagram of a programmable current mirror circuit used in the MOS type gm amplifier.

### DETAILED DESCRIPTION OF THE PREFERRED EMBODIMENTS

### First Embodiment

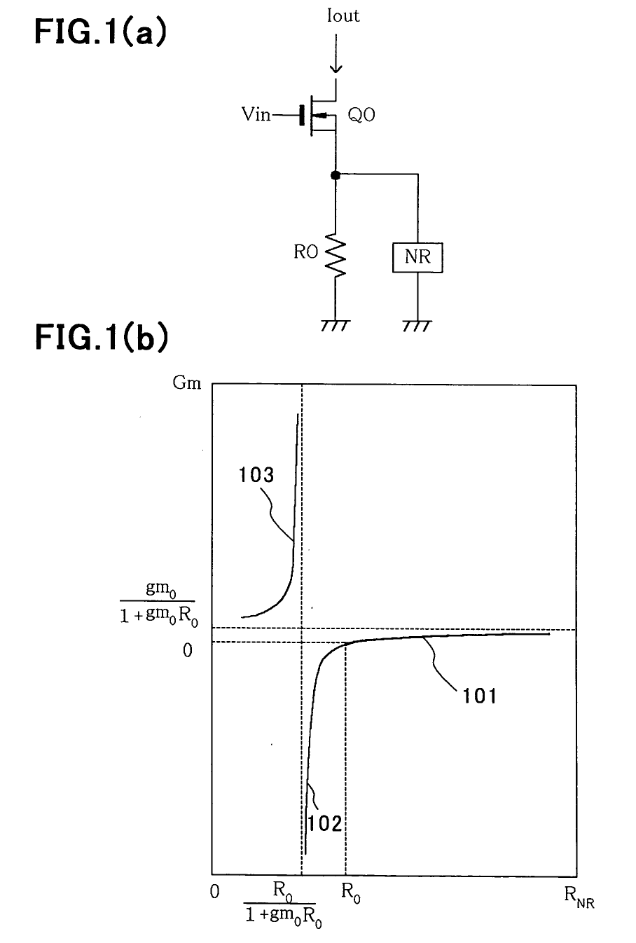

FIG. 1(a) is a circuit diagram of a voltage-current converting circuit in accordance with the first embodiment of the present invention, and FIG. 1(b) is used for explanation of an operation of the voltage-current converting circuit.

The voltage-current converting circuit in accordance with the first embodiment is comprised of an n-type MOSFET transistor Q0 acting as an active device carrying out voltage-current conversion, and a resistor circuit electrically connected in series to the n-type MOSFET transistor Q0. The resistor circuit is comprised of a positive resistor R0 electrically connected in series to the n-type MOSFET transistor Q0 and grounded, and a negative resistor NR electrically connected in series to the n-type MOSFET transistor Q0, electrically connected in parallel with the positive resistor R0, grounded, and having a variable resistance.

On entry of an input voltage signal Vin into a gate of the n-type MOSFET transistor Q0, there is obtained an output current Iout.

Hereinbelow is explained a principle of an operation of the voltage-current converting circuit (gm amplifier) in accordance with the first embodiment.

A mutual conductance Gm (Gm=Iout/Vout) of the voltage-current converting circuit in accordance with the first embodiment is expressed with the equation (2) which is obtained by replacing R with 1/(1/R₀−1/R_{NR}) in the equation (1).

$$Gm = \frac{1}{1 + \frac{1}{\frac{1}{{R}_{0}} - \frac{1}{{R}_{NR}}} {gm}_{0}} {gm}_{0} \qquad ( 2 )$$

In the equation (2), R0 indicates a resistance of the positive resistor R₀, R_{NR} indicates an absolute value of a resistance of the negative resistor NR, and gm₀ indicates a mutual conductance gm of the n-type MOSFET transistor Q0.

FIG. 1(b) is a graph showing how the mutual conductance Gm of the voltage-current converting circuit varies when the resistance R_{NR} varies in the equation (2).

As shown with a solid line 101 in FIG. 1(b), when the resistance R_{NR} of the negative resistor NR varies from R0 to infinity, the mutual conductance Gm can be varied from 0 to (gm₀/(1+gm₀·R)). That is, it is possible to vary the mutual conductance Gm to infinity.

As shown with a solid line 102 in FIG. 1(b), when the resistance R_{NR} varies from (R₀/(1+gm₀·R₀)) to R₀, the mutual conductance Gm can be varied from minus infinity to zero. That is, it is possible to vary the mutual conductance Gm to minus infinity.

As shown with a solid line 103 in FIG. 1(b), when the resistance R_{NR} varies from zero to (R₀/(1+gm₀·R₀)), the mutual conductance Gm can be varied from (gm₀/(1+gm₀·R)) to infinity. That is, it is possible to vary the mutual conductance Gm to infinity. If R₀ is set equal to 1/gm₀ (R₀=1/gm₀), it is possible to vary the mutual conductance Gm from gm₀/2 to infinity.

It should be noted that when the resistance R_{NR} is varied from (R₀/(1+gm₀·R₀)) to R₀, the mutual conductance Gm would be negative, and the output current Iout would run in an opposite direction in comparison with other cases. The first embodiment contains cases in which the mutual conductance Gm is negative.

In the voltage-current converting circuit in accordance with the first embodiment, it is not always necessary to vary the resistance R_{NR} of the negative resistor NR in a wide range. A range in which the resistance R_{NR} varies can be determined in accordance with a necessary variable range of the mutual conductance Gm. For instance, it is possible to vary the resistance R_{NR} of the negative resistor NR only in a finite range within a range from R₀ to infinity.

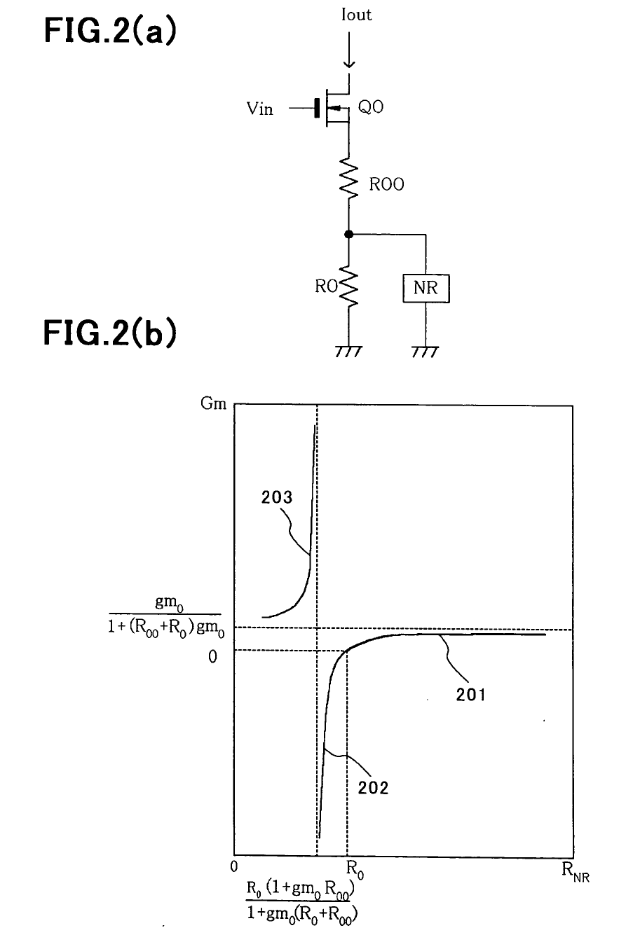

In the voltage-current converting circuit in accordance with the first embodiment, illustrated in FIG. 1, a number of a resistor device (the positive resistor R0) electrically connected in series to the n-type MOSFET transistor Q0 acting as an active device is one, but two or more resistor devices may be electrically connected in series to the n-type MOSFET transistor Q0. An example thereof is illustrated in FIG. 2 as a variant of the first embodiment.

FIG. 2(a) is a circuit diagram of a variant of the voltage-current converting circuit in accordance with the first embodiment of the present invention, and FIG. 2(b) is used for explanation of an operation of the variant.

The voltage-current converting circuit in accordance with the variant of the first embodiment is comprised of an n-type MOSFET transistor Q0 acting as an active device carrying out voltage-current conversion, and a resistor circuit electrically connected in series to the n-type MOSFET transistor Q0. The resistor circuit is comprised of a positive resistor R00 electrically connected in series to the n-type MOSFET transistor Q0, a positive resistor R0 electrically connected in series to the positive resistor R00 and grounded, and a negative resistor NR electrically connected in series to the positive resistor R00, electrically connected in parallel with the positive resistor R0, grounded, and having a variable resistance.

Similarly to the voltage-current converting circuit in accordance with the first embodiment, on entry of an input voltage signal Vin into a gate of the n-type MOSFET transistor Q0, there is obtained an output current Iout.

A mutual conductance Gm of the voltage-current converting circuit in accordance with the variant of the first embodiment is expressed with the equation (5) which is obtained by replacing R with (R₀₀+1/(1/R₀−1/R_{NR})) in the equation (1).

$$Gm = \frac{1}{1 + ( {R}_{00} + \frac{1}{\frac{1}{{R}_{0}} - \frac{1}{{R}_{NR}}} ) {gm}_{0}} {gm}_{0} \qquad ( 5 )$$

FIG. 2(b) is a graph showing how the mutual conductance Gm of the voltage-current converting circuit varies when the resistance R_{NR} of the negative resistor NR varies in the equation (5).

As shown with a solid line 201 in FIG. 2(b), when the resistance R_{NR} is equal to the resistance R₀(R_{NR}=R₀), the mutual conductance Gm is equal to zero. When the resistance R_{NR} is equal to infinity, the mutual conductance Gm is equal to (gm₀/(1+(R₀₀+R₀)·gm₀)). That is, the mutual conductance Gm can have an infinite variable range. By setting the resistances R₀ and R₀₀ equal to 1/gm₀(R₀=R₀₀=1/gm₀), the mutual conductance Gm is equal to gm₀/3.

As shown with a solid line 202 in FIG. 2(b), when the resistance R_{NR} varies from (R₀(1+gm₀·R₀₀)/(1+(R₀₀+R₀)gm₀)) to R₀, the mutual conductance Gm can be varied from minus infinity to zero. That is, it is possible to vary the mutual conductance Gm to minus infinity.

As shown with a solid line 203 in FIG. 2(b), when the resistance R_{NR} varies from zero to (R₀(1+gm₀·R₀₀)/(1+(R₀₀+R₀)gm₀)), the mutual conductance Gm can be varied from (gm₀/(1+(R₀₀+R₀) gm₀)) to infinity. That is, it is possible to vary the mutual conductance Gm to infinity.

As mentioned above, a plurality of resistors may be electrically connected in series to the n-type MOSFET transistor Q0, in which case, the negative resistance device NR is electrically connected in parallel with at least one of the resistors.

### Second Embodiment

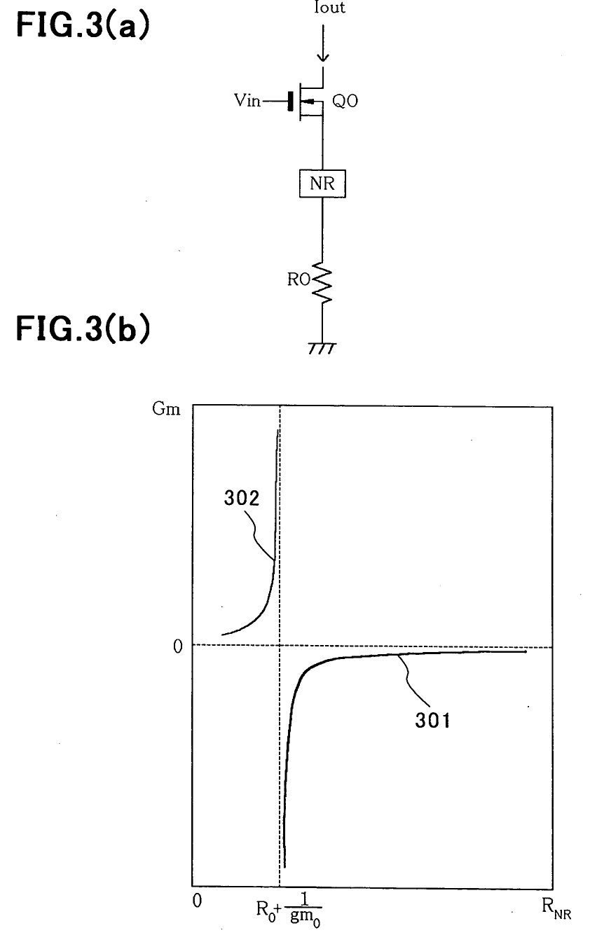

FIG. 3(a) is a circuit diagram of a voltage-current converting circuit in accordance with the second embodiment of the present invention, and FIG. 3(b) is used for explanation of an operation of the voltage-current converting circuit.

The voltage-current converting circuit in accordance with the second embodiment is comprised of an n-type MOSFET transistor Q0 acting as an active device carrying out voltage-current conversion, and a resistor circuit electrically connected in series to the n-type MOSFET transistor Q0. The resistor circuit is comprised of a negative resistor NR electrically connected in series to the n-type MOSFET transistor Q0, and having a variable resistance, and a positive resistor R0 electrically connected in series to the negative resistor NR and grounded.

A mutual conductance Gm of the voltage-current converting circuit in accordance with the second embodiment is expressed with the equation (3) which is obtained by replacing R with (R₀−R_{NR}) in the equation (1).

$$Gm = \frac{1}{1 + ( {R}_{0} - {R}_{NR} ) {gm}_{0}} {gm}_{0} \qquad ( 3 )$$

FIG. 3(b) is a graph showing how the mutual conductance Gm of the voltage-current converting circuit varies when the resistance R_{NR} of the negative resistor NR varies in the equation (3).

As shown with a solid line 301 in FIG. 3(b), when the resistance R_{NR} is equal to infinity, the mutual conductance Gm is equal to zero (Gm=0). When the resistance R_{NR} is equal to (R₀+1/gm₀), the mutual conductance Gm is equal to minus infinity (Gm=−∞). That is, the mutual conductance Gm can have an infinite variable range.

As shown with a solid line 302 in FIG. 3(b), when the resistance R_{NR} varies from zero to (R₀+1/gm₀), the mutual conductance Gm can be varied from zero to infinity. That is, it is possible to vary the mutual conductance Gm to infinity.

### Third Embodiment

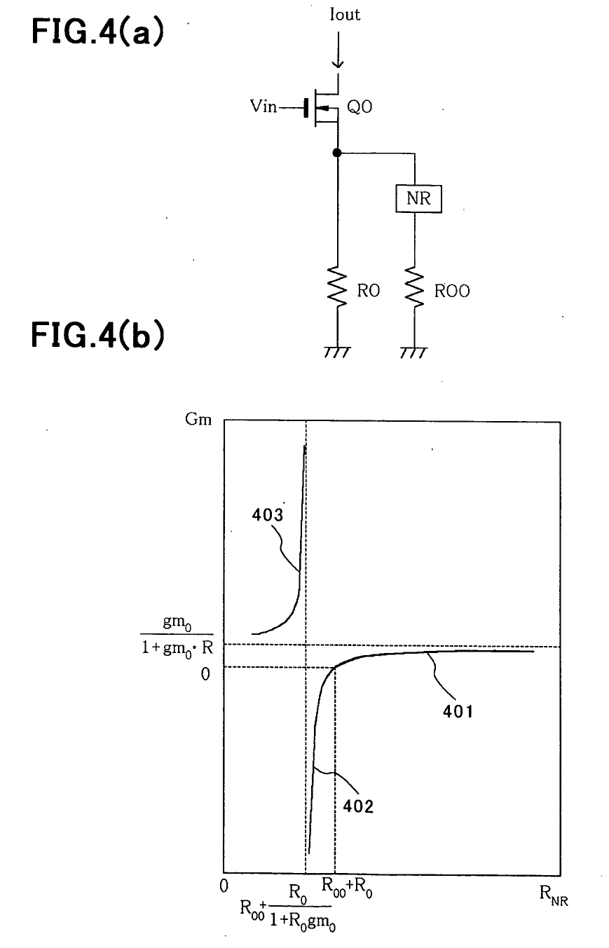

FIG. 4(a) is a circuit diagram of a voltage-current converting circuit in accordance with the third embodiment of the present invention, and FIG. 4(b) is used for explanation of an operation of the voltage-current converting circuit.

The voltage-current converting circuit in accordance with the third embodiment is comprised of an n-type MOSFET transistor Q0 acting as an active device carrying out voltage-current conversion, and a resistor circuit electrically connected in series to the n-type MOSFET transistor Q0. The resistor circuit is comprised of a positive resistor R0, as a first resistance device, electrically connected in series to the n-type MOSFET transistor Q0 and grounded, and a second resistor circuit electrically connected in parallel with the positive resistor R0. The second resistor circuit is comprised of a negative resistor NR electrically connected in series to the n-type MOSFET transistor Q0, and having a variable resistance, and a positive resistor R00, as a second resistance device, electrically connected in series to the negative resistor NR, and grounded.

A mutual conductance Gm of the voltage-current converting circuit in accordance with the third embodiment is expressed with the equation (4) which is obtained by replacing R with 1/(1/R₀−1/(R_{NR}−R₀₀)) in the equation (1). R₀₀ indicates a resistance of the positive resistor R00.

$$Gm = \frac{1}{1 + ( \frac{1}{\frac{1}{{R}_{0}} - \frac{1}{{R}_{NR} - {R}_{00}}} ) {gm}_{0}} {gm}_{0} \qquad ( 4 )$$

FIG. 4(b) is a graph showing how the mutual conductance Gm of the voltage-current converting circuit varies when the resistance R_{NR} of the negative resistor NR varies in the equation (4).

As shown with a solid line 401 in FIG. 4(b), when the resistance R_{NR} is equal to R₀+R₀₀, the mutual conductance Gm is equal to zero (Gm=0). When the resistance R_{NR} is equal to infinity, the mutual conductance Gm is equal to (gm₀/(1+gm₀·R)). That is, the mutual conductance Gm can have an infinite variable range. By setting the resistances R₀ of the positive resistor R0 equal to 1/gm₀ (R₀=1/gm₀), the mutual conductance Gm is equal to gm₀/2.

As shown with a solid line 402 in FIG. 4(b), when the resistance R_{NR} varies from (R₀₀+R₀/(1+R₀ gm₀) to R₀+R₀₀, the mutual conductance Gm can be varied from minus infinity to zero. That is, it is possible to vary the mutual conductance Gm to minus infinity.

As shown with a solid line 403 in FIG. 4(b), when the resistance R_{NR} varies from zero to (R₀₀+R₀/(1+R₀ gm₀), the mutual conductance Gm can be varied from (gm₀/(1+gm₀·R)) to infinity. That is, it is possible to vary the mutual conductance Gm to infinity.

### Fourth Embodiment

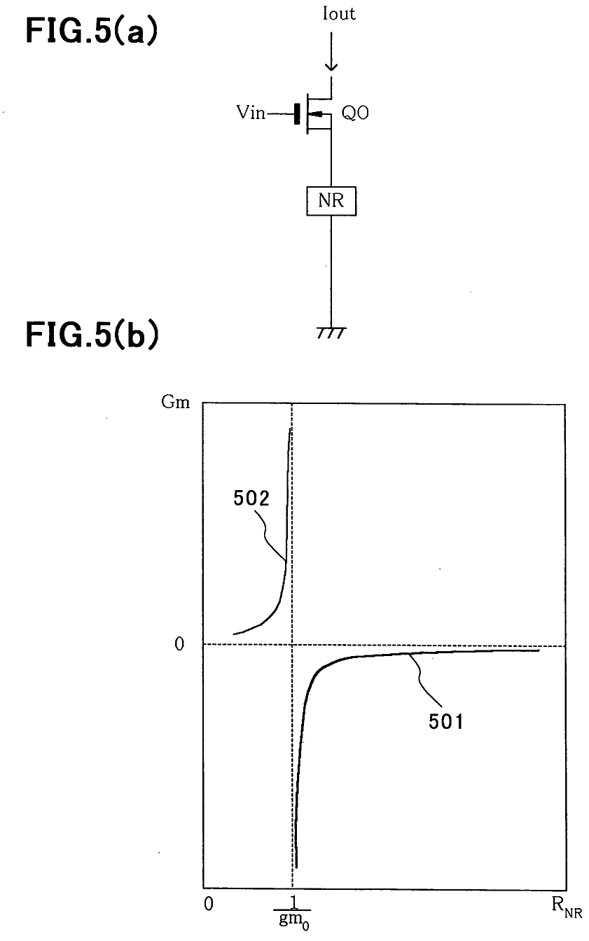

FIG. 5(a) is a circuit diagram of a voltage-current converting circuit in accordance with the fourth embodiment of the present invention, and FIG. 5(b) is used for explanation of an operation of the voltage-current converting circuit.

The voltage-current converting circuit in accordance with the fourth embodiment is comprised of an n-type MOSFET transistor Q0 acting as an active device carrying out voltage-current conversion, and a resistor circuit electrically connected in series to the n-type MOSFET transistor Q0. The resistor circuit is comprised only of a negative resistor NR having a variable resistance.

A mutual conductance Gm of the voltage-current converting circuit in accordance with the fourth embodiment is expressed with the equation (6) which is obtained by replacing R with (−R_{NR}) in the equation (1).

$$Gm = \frac{1}{1 - {R}_{NR} \cdot {gm}_{0}} {gm}_{0} \qquad ( 6 )$$

FIG. 5(b) is a graph showing how the mutual conductance Gm of the voltage-current converting circuit varies when the resistance R_{NR} of the negative resistor NR varies in the equation (6).

As shown with a solid line 501 in FIG. 5(b), when the resistance R_{NR} is equal to (1/gm₀), the mutual conductance Gm is equal to minus infinity. When the resistance R_{NR} is equal to infinity, the mutual conductance Gm is equal to zero (Gm=0). That is, the mutual conductance Gm can have an infinite variable range.

As shown with a solid line 502 in FIG. 5(b), when the resistance R_{NR} varies from zero to (1/gm₀), the mutual conductance Gm can be varied from zero to infinity. That is, it is possible to vary the mutual conductance Gm to infinity.

Though a n-type MOSFET transistor is used as an active device for carrying out voltage-current conversion in the above-mentioned first to fourth embodiments, it should be noted that any active device such as a bipolar transistor or a MESFET may be used in place of a n-type MOSFET transistor.

Though the negative resistor NR is designed to have a variable resistance in the above-mentioned first to fourth embodiments, it should be noted that the negative resistor may be designed to have a fixed resistance, and the positive resistors R0 and R00 may be designed to have a variable resistance.

For instance, in the voltage-current converting circuit in accordance with the first embodiment, illustrated in FIG. 1(a), if the positive resistor R0 is designed to have a variable resistance, it would be possible to vary the mutual conductance Gm from zero to infinity by varying the resistance R₀ from R_{NR} to infinity in the equation (2), assuming that R_{NR} is equal to 1/gm₀. Thus, it is possible to vary the mutual conductance Gm to infinity. Those negative or positive variable resistors can be comprised of an active device such as a MOSFET transistor.

In the above-mentioned first to fourth embodiments, two active devices each carrying out voltage-current conversion may be connected in cross to each other such that they differentially operate, and complementary input voltages may be input into the two active devices to have complementary output currents. Hereinbelow are explained embodiments in which two active devices are electrically connected in cross to each other such that they differentially operate.

### Fifth Embodiment

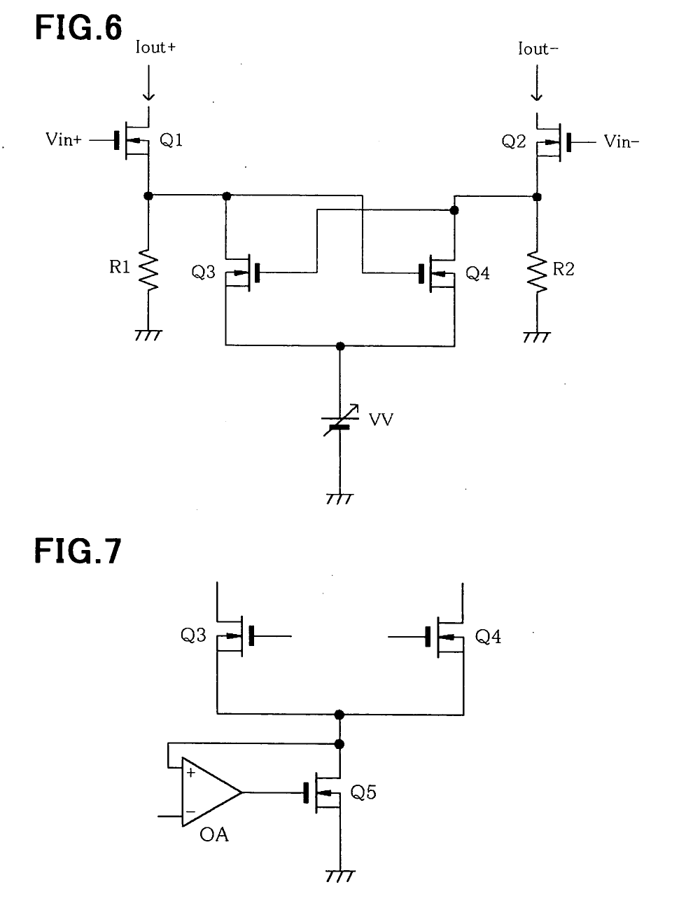

FIG. 6(a) is a circuit diagram of a voltage-current converting circuit in accordance with the fifth embodiment of the present invention.

The voltage-current converting circuit in accordance with the fifth embodiment is comprised of n-type MOSFET transistors Q1 and Q2 each as an active device carrying out voltage-current conversion, positive resistors R1 and R2 electrically connected in series to the n-type MOSFET transistors Q1 and Q2, respectively, and grounded, a resistor circuit electrically connected between a junction node at which the n-type MOSFET transistor Q1 and the positive resistor R1 are electrically connected to each other and a junction node at which the n-type MOSFET transistor Q2 and the positive resistor R2 are electrically connected to each other, and a variable voltage source VV electrically connected in series to the resistor circuit and grounded.

The resistor circuit is comprised of n-type MOSFET transistors Q3 and Q4 having the same size as each other and acting as a negative resistor.

The n-type MOSFET transistor Q3 has a gate electrically connected to a junction node at which the n-type MOSFET transistor Q2 and the positive resistor R2 are electrically connected to each other, a drain electrically connected to a junction node at which the n-type MOSFET transistor Q1 and the positive resistor R1 are electrically connected to each other, and a source electrically connected to the variable voltage source VV.

The n-type MOSFET transistor Q4 has a gate electrically connected to a junction node at which the n-type MOSFET transistor Q1 and the positive resistor R1 are electrically connected to each other, a drain electrically connected to a junction node at which the n-type MOSFET transistor Q2 and the positive resistor R2 are electrically connected to each other, and a source electrically connected to the variable voltage source VV.

The n-type MOSFET transistors Q1 and Q2 have the same size as each other, and output currents Iout+ and Iout− on receipt of input voltage signals Vin+ and Vin− through the gates thereof, respectively. The positive resistors R1 and R2 have the same resistances as each other.

In a MOSFET transistor circuit having a grounded source, a source, a drain and a gate correspond to a grounded terminal, an output terminal and a control terminal, respectively. The positive resistors R1 and R2 and the n-type MOSFET transistors Q3 and Q4 are all electrically connected to sources or grounded terminals of the n-type MOSFET transistors Q1 and Q2.

Hereinbelow is explained a principle of an operation of the voltage-current converting circuit (gm amplifier) in accordance with the fifth embodiment.

Since the voltage-current converting circuit in accordance with the fifth embodiment is equivalent to a circuit having the same structure as that of the voltage-current converting circuit in accordance with the first embodiment, illustrated in FIG. 1, except the negative resistor NR is replaced with the n-type MOSFET transistor Q3, the resistance R_{NR} is equal to 1/gm_{Q3}. Accordingly, a mutual conductance Gm (Gm=(Iout+Iout−)/(Vin+−Vin−)) of the voltage-current converting circuit in accordance with the fifth embodiment is expressed with the equation (7) which is obtained by replacing R with 1/(1/R_{R1}−gm_{Q3}) in the equation (1).

$$Gm = \frac{1}{1 + \frac{1}{\frac{1}{{R}_{R1}} - {gm}_{Q3}} {gm}_{0}} {gm}_{0} \qquad ( 7 )$$

In the equation (7), R_{R1} indicates a resistance of the positive resistors R1 and R2, gm_{Q3} indicates a mutual conductance gm of the n-type MOSFET transistors Q3 and Q4, and gm₀ indicates a mutual conductance gm of the n-type MOSFET transistors Q1 and Q2.

As is obvious in view of the equation (7), it is possible to vary the mutual conductance Gm from zero to (gm₀/(1+gm₀·R_{R1})) by varying the mutual conductance gm_{Q3} of the n-type MOSFET transistors Q3 and Q4 from 1/R_{R1} to zero. That is, the mutual conductance Gm can have an infinite variable range.

The mutual conductance gm_{Q3} of the n-type MOSFET transistors Q3 and Q4 can be controlled in light of the fact that the mutual conductance Gm is in proportion with a voltage Vgs between a gate and a source. Specifically, the voltage Vgs between a gate and a source of the n-type MOSFET transistors Q3 and Q4 is controlled by varying a voltage of the variable voltage source VV electrically connected to the sources of the n-type MOSFET transistors Q3 and Q4.

For instance, by designing the n-type MOSFET transistors Q3 and Q4 such that the mutual conductance gm_{Q3} of the n-type MOSFET transistors Q3 and Q4 has a maximum 1/R_{R1} when a voltage of the variable voltage source VV is in maximum, the mutual conductance gm_{Q3} of the n-type MOSFET transistors Q3 and Q4 becomes zero when a voltage of the variable voltage source VV is raised up to a drain voltage of the n-type MOSFET transistors Q3 and Q4. Hence, the mutual conductance Gm of the voltage-current converting circuit in accordance with the fifth embodiment varies from zero to (gm₀/(1+gm₀·R_{R1})). That is, the mutual conductance Gm can have an infinite variable range.

FIG. 7 is a circuit diagram of an example of the variable voltage source VV.

In FIG. 7, the n-type MOSFET transistors Q3 and Q4 acting as a negative resistance device in the voltage-current converting circuit in accordance with the fifth embodiment, illustrated in FIG. 6, are also illustrated.

The variable voltage source VV illustrated in FIG. 7 is comprised of an operational amplifier OA having a first input terminal (minus (−) terminal), a second input terminal (plus (+) terminal), and an output terminal, and an n-type MOSFET transistor Q5 acting as an active device. A voltage-control signal is input into the first input terminal (minus (−) terminal) of the operational amplifier OA. An input terminal (gate) of the n-type MOSFET transistor Q5 is electrically connected to the output terminal of the operational amplifier OA, an output terminal (drain) of the n-type MOSFET transistor Q5 is electrically connected to the second input terminal (plus (+) terminal) of the operational amplifier OA, and a ground terminal (source) is grounded.

The n-type MOSFET transistor Q5 acts as a voltage source. By electrically connecting a drain voltage of the n-type MOSFET transistor Q5 to the second input terminal (plus (+) terminal) of the operational amplifier OA, and electrically connecting an output terminal of the operational amplifier OA to a gate of the n-type MOSFET transistor Q5, a control voltage input into the first input terminal (minus (−) terminal) of the operational amplifier OA can be applied to a drain voltage of the n-type MOSFET transistor Q5, that is, a source voltage of the n-type MOSFET transistors Q3 and Q4.

Furthermore, since the n-type MOSFET transistors Q3 and Q4 operate differentially each other, a current running through a drain of the n-type MOSFET transistor Q5 has no AC components. Accordingly, the operational amplifier OA is not required to operate in a high-frequency band, ensuring that the variable voltage source VV illustrated in FIG. 7 can act as a stable voltage source.

### Sixth Embodiment

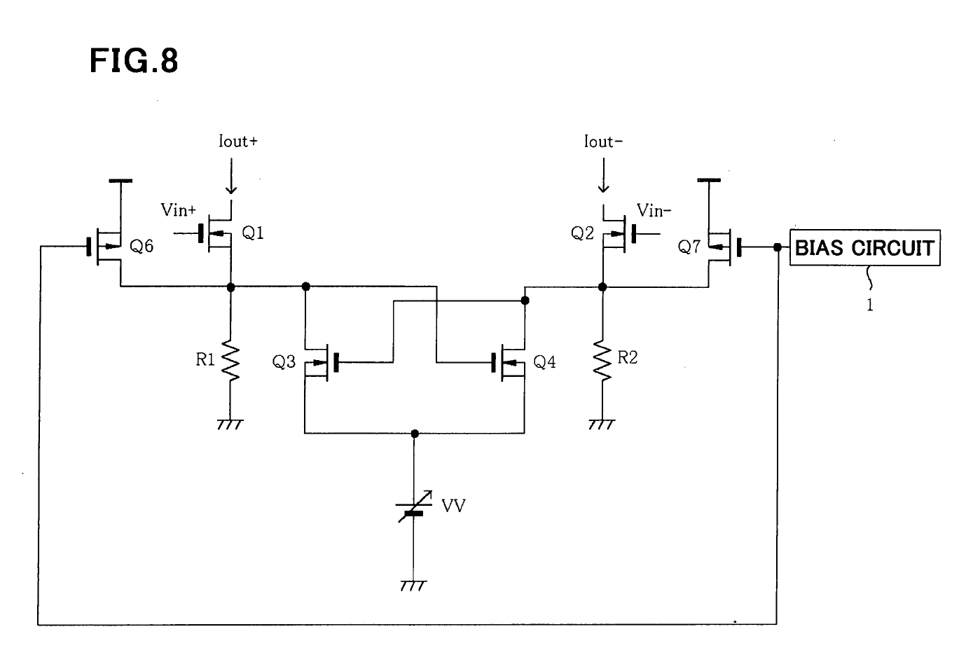

FIG. 8 is a circuit diagram of a voltage-current converting circuit in accordance with the sixth embodiment of the present invention.

The voltage-current converting circuit in accordance with the sixth embodiment additionally includes p-type MOSFET transistors Q6 and Q7, and a bias circuit 1 in comparison with the voltage-current converting circuit in accordance with the fifth embodiment, illustrated in FIG. 6. Hence, parts or elements in FIG. 8 that correspond to those of FIG. 6 have been provided with the same reference numerals.

The p-type MOSFET transistor Q6 has a source electrically connected to a source of the n-type MOSFET transistor Q1, the positive resistor R1, a drain of the n-type MOSFET transistor Q3, and a gate of the n-type MOSFET transistor Q4, and a gate electrically connected to the bias circuit 1. The p-type MOSFET transistor Q7 has a source electrically connected to a source of the n-type MOSFET transistor Q2, the positive resistor R2, a drain of the n-type MOSFET transistor Q4, and a gate of the n-type MOSFET transistor Q3, and a gate electrically connected to the bias circuit 1. The bias circuit 1 applies a bias voltage to gates of the p-type MOSFET transistors Q6 and Q7.

In the voltage-current converting circuit in accordance with the fifth embodiment, illustrated in FIG. 6, when a voltage of the variable voltage source VV is varied, a DC current running into drains of the n-type MOSFET transistors Q3 and Q4 varies, and further, a source voltage of the n-type MOSFET transistors Q1 and Q2 also varies. Since the mutual conductance gin of the n-type MOSFET transistors Q1 and Q2 varies in proportion with the voltage Vgs applied across a gate and a source, the mutual conductance gm₀ of the n-type MOSFET transistors Q1 and Q2 in the equation (7) is not constant, but varies in accordance with a voltage of the variable voltage source VV. If the mutual conductance gm₀ of the n-type MOSFET transistors Q1 and Q2 is not constant, a voltage-current converting circuit (gm amplifier) unavoidably has a complex structure. In addition, each of the MOSFET transistors may operate in an unsaturated area in accordance with a voltage of the variable voltage source VV.

In contrast, in the sixth embodiment, the p-type MOSFET transistors Q6 and Q7 are electrically connected to the sources of the n-type MOSFET transistors Q1 and Q2, and a bias voltage associated with a voltage of the variable voltage source VV, provided from the bias circuit 1, is applied to the gates of the p-type MOSFET transistors Q6 and Q7. This ensures that fluctuated DC current is compensated for. Thus, a DC voltage at the sources of the n-type MOSFET transistors Q1 and Q2 is constant independently of a voltage of the variable voltage source VV, and hence, the mutual conductance gm₀ of the n-type MOSFET transistors Q1 and Q2 is also constant.

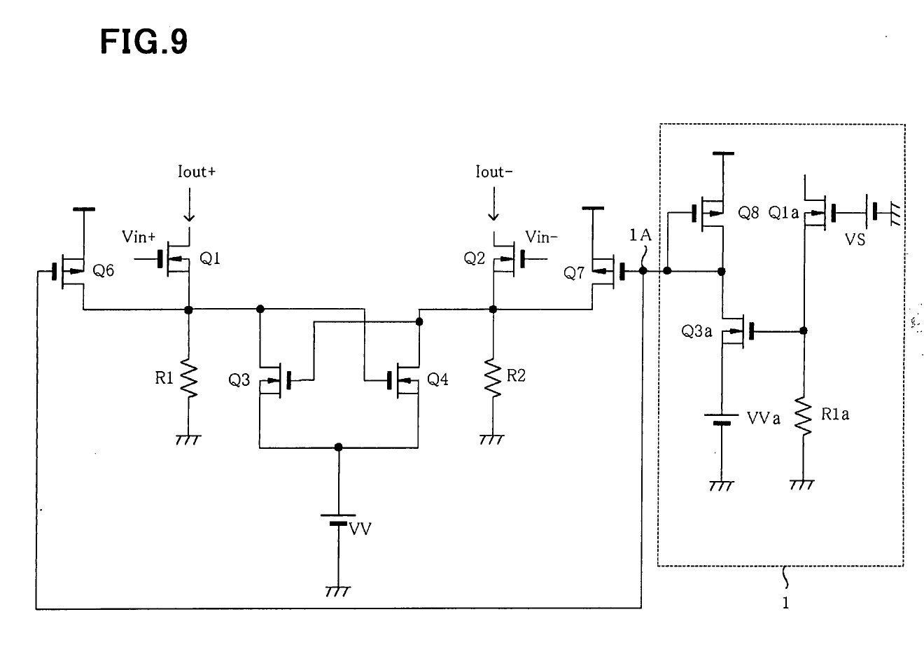

FIG. 9 is a circuit diagram of an example of the bias circuit in the sixth embodiment of the present invention, together with a circuit diagram of an example of the bias circuit 1.

As illustrated in FIG. 9, the bias circuit 1 is comprised, for instance, of a p-type MOSFET transistor Q8, a n-type MOSFET transistor Q3a, a n-type MOSFET transistor Q1a, a positive resistor R1a, a variable voltage source VVa, and a constant voltage source VS.

A gate and a drain in the p-type MOSFET transistor Q8 are short-circuited with each other, and are electrically connected to an output terminal 1A of the bias circuit 1 and a source of the n-type MOSFET transistor Q3a. The n-type MOSFET transistor Q3a has a drain electrically connected to the variable voltage source VVa, a source electrically connected to a gate and a source of the p-type MOSFET transistor Q8, and a gate electrically connected to a junction node at which the n-type MOSFET transistor Q1a and the positive resistor R1a are electrically connected to each other. The variable voltage source VVa is electrically connected at one end thereof to a drain of the n-type MOSFET transistor Q3a, and at the other end grounded. The n-type MOSFET transistor Q1a has a gate electrically connected to the variable voltage source VVa, and a source electrically connected to a gate of the n-type MOSFET transistor Q3a and the positive resistor R1a. The positive resistor R1a is electrically connected at one end thereof to a gate of the n-type MOSFET transistor Q3a and a source of the n-type MOSFET transistor Q1a, and at the other end grounded.

The n-type MOSFET transistor Q1a, the n-type MOSFET transistor Q3a, the positive resistor R1a, and the variable voltage source VVa all in the bias circuit 1 correspond to the n-type MOSFET transistor Q1, the n-type MOSFET transistor Q3, the positive resistor R1, and the variable voltage source VV all in the voltage-current converting circuit in accordance with the sixth embodiment, illustrated in FIG. 8. A current running across a drain and a source of the n-type MOSFET transistor Q3a is identical with the same in the n-type MOSFET transistor Q3.

The constant voltage source VS providing a voltage (Vin+−Vin−)/2 is electrically connected to a gate of the n-type MOSFET transistor Q1a.

A source of the p-type MOSFET transistor Q8 having a gate and a drain short-circuited with each other is electrically connected to a drain of the n-type MOSFET transistor Q3a. A gate voltage of the p-type MOSFET transistor Q8 is applied to gates of the n-type MOSFET transistors Q6 and Q7 as a bias voltage.

In the voltage-current converting circuit illustrated in FIG. 9, when a voltage of the variable voltage source VV varies, a current running through the n-type MOSFET transistors Q3 and Q4 varies, and a voltage of the variable voltage source VVa also varies. Hence, a current fluctuation in the n-type MOSFET transistors Q3 and Q4 reflects on a current fluctuation in the n-type MOSFET transistor Q3a, and accordingly, on a current fluctuation in the p-type MOSFET transistor Q8.

Since the p-type MOSFET transistor Q8 and the p-type MOSFET transistors Q6 and Q7 define a current mirror circuit, a current fluctuation in the n-type MOSFET transistors Q3 and Q4 is applied to the n-type MOSFET transistor Q3a through the p-type MOSFET transistors Q6 and Q7. Accordingly, it is possible to keep a current running through n-type MOSFET transistors Q1 and Q2 constant, even if a voltage of the variable voltage source VV varies. Thus, it is possible to keep a source voltage in the n-type MOSFET transistors Q1 and Q2 constant, and hence, it is also possible to keep the mutual conductance of the n-type MOSFET transistors Q1 and Q2 constant.

### Seventh Embodiment

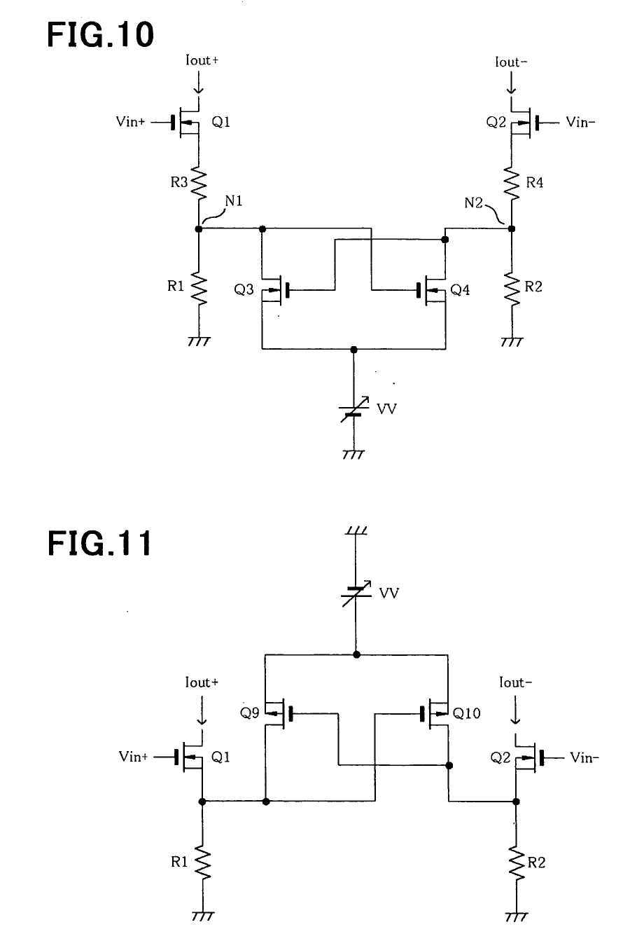

FIG. 10 is a circuit diagram of a voltage-current converting circuit in accordance with the seventh embodiment of the present invention.

The voltage-current converting circuit in accordance with the seventh embodiment additionally includes positive resistors R3 and R4 in comparison with the voltage-current converting circuit in accordance with the fifth embodiment, illustrated in FIG. 6. Hence, parts or elements in FIG. 10 that correspond to those of FIG. 6 have been provided with the same reference numerals.

The positive resistor R3 is electrically connected in series between a source of the n-type MOSFET transistor Q1 and a junction node N1 at which the positive resistor R1, a drain of the n-type MOSFET transistor Q3, and a gate of the n-type MOSFET transistor Q4 are electrically connected to one another. The positive resistor R4 is electrically connected in series between a source of the n-type MOSFET transistor Q2 and a junction node N2 at which the positive resistor R2, a drain of the n-type MOSFET transistor Q4, and a gate of the n-type MOSFET transistor Q3 are electrically connected to one another.

In the voltage-current converting circuit in accordance with the fifth embodiment, illustrated in FIG. 6, the drains of the n-type MOSFET transistors Q3 and Q4 each acting as a negative resistance device are electrically connected to a junction node at which a source of the n-type MOSFET transistor Q1 and the positive resistor R1 are electrically connected to each other and a junction node at which a source of the n-type MOSFET transistor Q2 and the positive resistor R2 are electrically connected to each other, respectively. In contrast, in the seventh embodiment, the drains of the n-type MOSFET transistors Q3 and Q4 each acting as a negative resistance device are electrically connected to the above-mentioned junction nodes N1 and N2, respectively.

The mutual conductance Gm of the voltage-current converting circuit in accordance with the seventh embodiment is obtained by replacing R with (R_{R3}+1/(1/R_{R1}−gm_{Q3})) in the equation (1), wherein R_{R3} indicates a resistance of the positive resistor R3. That is, the mutual conductance Gm is equal to a sum of the mutual conductance of the voltage-current converting circuit in accordance with the fifth embodiment, and the resistance R_{R3}.

The voltage-current converting circuit in accordance with the seventh embodiment provides the same advantages as those obtained by the voltage-current converting circuit in accordance with the first embodiment. Furthermore, since the positive resistors R3 and R4 are electrically connected between the sources of the n-type MOSFET transistors Q1 and Q2, and the negative resistor NR, non-linearity of the n-type MOSFET transistors Q3 and Q4 is relaxed, ensuring that the voltage-current converting circuit (gm amplifier) can accomplish more linear operation.

### Eighth Embodiment

FIG. 11 is a circuit diagram of a voltage-current converting circuit in accordance with the eighth embodiment of the present invention.

The voltage-current converting circuit in accordance with the eighth embodiment includes p-type MOSFET transistors Q9 and Q10 in place of the n-type MOSFET transistors Q3 and Q4 each acting as a negative resistance device, in comparison with the voltage-current converting circuit in accordance with the fifth embodiment, illustrated in FIG. 6. The voltage-current converting circuit in accordance with the eighth embodiment is structurally identical with the voltage-current converting circuit in accordance with the fifth embodiment except the above-mentioned difference. Hence, parts or elements in FIG. 11 that correspond to those of FIG. 6 have been provided with the same reference numerals.

The voltage-current converting circuit in accordance with the eighth embodiment in which electrical conductivity of the MOSFET transistors defining a negative resistance device is changed to p-type from n-type in comparison with the fifth embodiment provides the same advantages as those obtained by the voltage-current converting circuit in accordance with the fifth embodiment, illustrated in FIG. 6.

### Ninth Embodiment

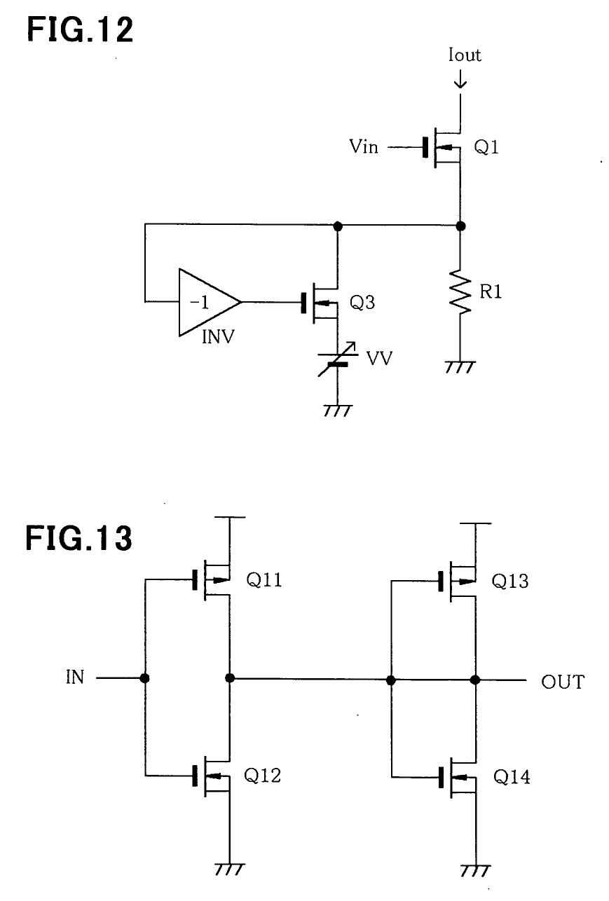

FIG. 12 is a circuit diagram of a voltage-current converting circuit in accordance with the ninth embodiment of the present invention.

Whereas the voltage-current converting circuit in accordance with the fifth embodiment, illustrated in FIG. 6, is a differential circuit, the voltage-current converting circuit in accordance with the ninth embodiment defines a single-end type gm amplifier. Hence, parts or elements in FIG. 12 that correspond to those of FIG. 6 have been provided with the same reference numerals. As an alternative, the voltage-current converting circuit in accordance with the ninth embodiment has a negative resistance device NR having a different structure from that of the voltage-current converting circuit in accordance with the first embodiment, illustrated in FIG. 1.

The voltage-current converting circuit in accordance with the ninth embodiment is comprised of an n-type MOSFET transistor Q1, a positive resistor R1, and a resistor circuit.

The n-type MOSFET transistor Q1 receives an input voltage signal Vin through a gate thereof, and outputs an output current Iout. A source of the n-type MOSFET transistor Q1 is electrically connected to the positive resistor R1 and the resistor circuit.

The positive resistor R1 is electrically connected at one end thereof to a source of the n-type MOSFET transistor Q1, and at the other end grounded.

The resistor circuit is comprised of an n-type MOSFET transistor Q3 acting as a negative resistance device, a phase-inverting circuit INV, and a variable voltage source VV.

The n-type MOSFET transistor Q3 has a drain electrically connected to a junction node at which a source of the n-type MOSFET transistor Q1 and the positive resistor R1 are electrically connected to each other, and further to an input terminal of the phase-inverting circuit INV, a source electrically connected to the variable voltage source VV, and a gate electrically connected to an output terminal of the phase-inverting circuit INV.

The phase-inverting circuit INV has an input terminal electrically connected to a junction node at which a drain of the n-type MOSFET transistor Q3, a source of the n-type MOSFET transistor Q1, and the positive resistor R1 are electrically connected to one another, and an output terminal electrically connected to a gate of the n-type MOSFET transistor Q3.

The variable voltage source VV is electrically connected at one end thereof to a source of the n-type MOSFET transistor Q3, and at the other end grounded.

A phase-inverted signal obtained by inverting a voltage signal of a drain of the n-type MOSFET transistor Q3 through the phase-inverting circuit INV is input into a gate of the n-type MOSFET transistor Q3 acting as a negative resistance device.

FIG. 13 is a circuit diagram of an example of the phase-inverting circuit INV.

As illustrated in FIG. 13, the phase-inverting circuit INV is comprised of p-type MOSFET transistors Q11, Q13 and n-type MOSFET transistors Q12, Q14.

The p-type MOSFET transistor Q11 and the n-type MOSFET transistor Q12 define an inverter, and the p-type MOSFET transistor Q13 and the n-type MOSFET transistor Q14 define an inverter-type load in which an input terminal and an output terminal are short-circuited with each other. These two inverters are designed to have a theoretical threshold voltage equal to a DC bias at a junction node at which the positive resistor R1 and a drain of the n-type MOSFET transistor Q3 are electrically connected to each other.

A negative resistance of the n-type MOSFET transistor Q3 is controlled by controlling a voltage of the variable voltage source VV to thereby vary a voltage between a source and a gate of the n-type MOSFET transistor Q3.

### Tenth Embodiment

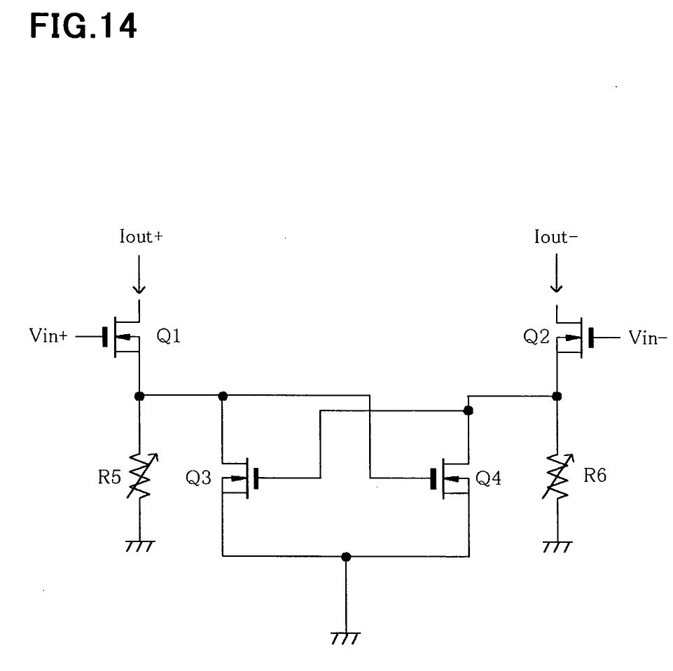

FIG. 14 is a circuit diagram of a voltage-current converting circuit in accordance with the tenth embodiment of the present invention.

The voltage-current converting circuit in accordance with the tenth embodiment does not include the variable voltage source VV, but includes variable resistors R5 and R6 each having a positive resistance, in place of the positive resistors R1 and R2, in comparison with the voltage-current converting circuit in accordance with the fifth embodiment, illustrated in FIG. 6. The voltage-current converting circuit in accordance with the tenth embodiment is structurally identical with the voltage-current converting circuit in accordance with the fifth embodiment except the above-mentioned difference. Hence, parts or elements in FIG. 14 that correspond to those of FIG. 6 have been provided with the same reference numerals.

In the voltage-current converting circuit in accordance with the fifth embodiment, illustrated in FIG. 6, a gain of the voltage-current converting circuit is controlled by controlling a negative resistance. In contrast, in the tenth embodiment, a gain of the voltage-current converting circuit is controlled by controlling the variable positive resistors R5 and R6.

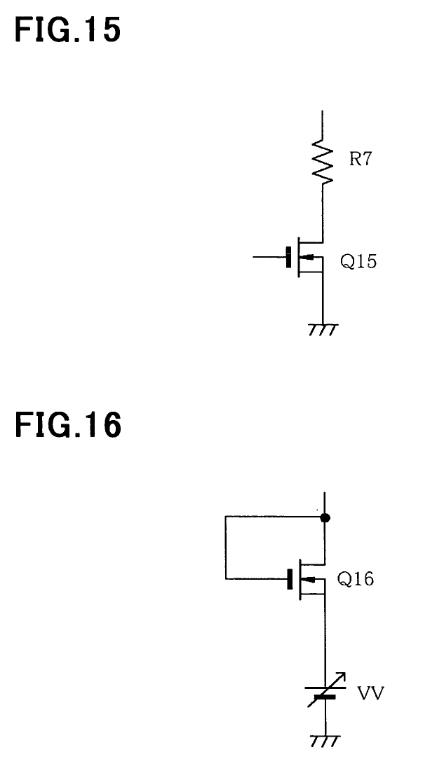

FIG. 15 is a circuit diagram of an example of the variable positive resistors R5 and R6.

For instance, the variable positive resistor R5 or R6 is comprised of a positive resistor R7, and an n-type MOSFET transistor Q15 electrically connected in series to the positive resistor R7.

The n-type MOSFET transistor Q15 is used in an unsaturated area in which Vgs is greater than (Vds+Vth) so as to use the n-type MOSFET transistor Q15 as a resistor, wherein Vgs indicates a voltage between a gate and a source, Vds indicates a voltage between a drain and a source, and Vth indicates a threshold voltage of the n-type MOSFET transistor Q15. A resistance of the n-type MOSFET transistor Q15 is controlled in accordance with a bias voltage input into a gate of the n-type MOSFET transistor Q15.

FIG. 16 is a circuit diagram of another example of the variable positive resistors R5 and R6.

For instance, the variable positive resistor R5 or R6 is comprised of a n-type MOSFET transistor Q16 in which a gate and a drain are short-circuited with each other, and a variable voltage source VV electrically connected at one end thereof in series to a source of the n-type MOSFET transistor Q16, and at the other end grounded.

A positive resistance of the variable positive resistors R5 and R6 is controlled by controlling a voltage of the variable voltage source VV to thereby vary a voltage between a gate and a source in the n-type MOSFET transistor Q16.

In the voltage-current converting circuit in accordance with the tenth embodiment, illustrated in FIG. 14, a voltage source providing a constant voltage may be arranged between sources of the n-type MOSFET transistors Q3 and Q4, and a grounded voltage.

### Eleventh Embodiment

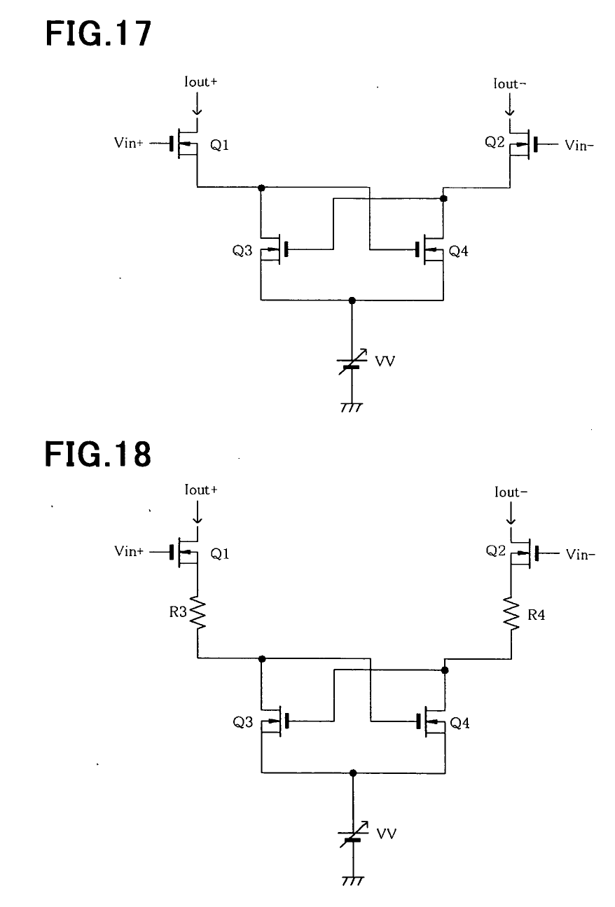

FIG. 17 is a circuit diagram of a voltage-current converting circuit in accordance with the eleventh embodiment of the present invention.

The voltage-current converting circuit in accordance with the eleventh embodiment does not include the resistors R1 and R2, in comparison with the voltage-current converting circuit in accordance with the fifth embodiment, illustrated in FIG. 6. The voltage-current converting circuit in accordance with the eleventh embodiment is structurally identical with the voltage-current converting circuit in accordance with the fifth embodiment, illustrated in FIG. 6, except the above-mentioned difference. Hence, parts or elements in FIG. 17 that correspond to those of FIG. 6 have been provided with the same reference numerals.

The mutual conductance Gm of the voltage-current converting circuit in accordance with the eleventh embodiment is obtained by setting the resistance R_{R1} of the positive resistor R1 to be equal to infinite in the equation (2).

The voltage-current converting circuit in accordance with the eleventh embodiment makes it possible to much vary the mutual conductance Gm thereof even by small fluctuation of a voltage provided from the variable voltage source VV.

### Twelfth Embodiment

FIG. 18 is a circuit diagram of a voltage-current converting circuit in accordance with the twelfth embodiment of the present invention.

The voltage-current converting circuit in accordance with the twelfth embodiment does not include the resistors R1 and R2, in comparison with the voltage-current converting circuit in accordance with the seventh embodiment, illustrated in FIG. 10. As an alternative, the voltage-current converting circuit in accordance with the twelfth embodiment additionally includes positive resistors R3 and R4 in comparison with the voltage-current converting circuit in accordance with the eleventh embodiment, illustrated in FIG. 17.

The positive resistor R3 is electrically connected in series between a source of the n-type MOSFET transistor Q1, and a drain of the n-type MOSFET transistor Q3 and a gate of the n-type MOSFET transistor Q4. The positive resistor R4 is electrically connected in series between a source of the n-type MOSFET transistor Q2, and a drain of the n-type MOSFET transistor Q4 and a gate of the n-type MOSFET transistor Q3.

The voltage-current converting circuit in accordance with the twelfth embodiment is structurally identical with either the voltage-current converting circuit in accordance with the seventh embodiment, illustrated in FIG. 10, or the voltage-current converting circuit in accordance with the eleventh embodiment, illustrated in FIG. 17, except the above-mentioned difference. Hence, parts or elements in FIG. 18 that correspond to those of FIG. 10 or FIG. 17 have been provided with the same reference numerals.

The mutual conductance Gm of the voltage-current converting circuit in accordance with the twelfth embodiment is obtained by replacing R with (R_{R3}−1/gm_{Q3})) in the equation (1).

The voltage-current converting circuit in accordance with the twelfth embodiment provides the same advantages as those obtained by the voltage-current converting circuit in accordance with the eleventh embodiment. Furthermore, since the positive resistors R3 and R4 are electrically connected between the sources of the n-type MOSFET transistors Q1 and Q2, and the negative resistor NR, non-linearity of the n-type MOSFET transistors Q3 and Q4 is relaxed, ensuring that the voltage-current converting circuit can accomplish more linear operation.

### Thirteenth Embodiment

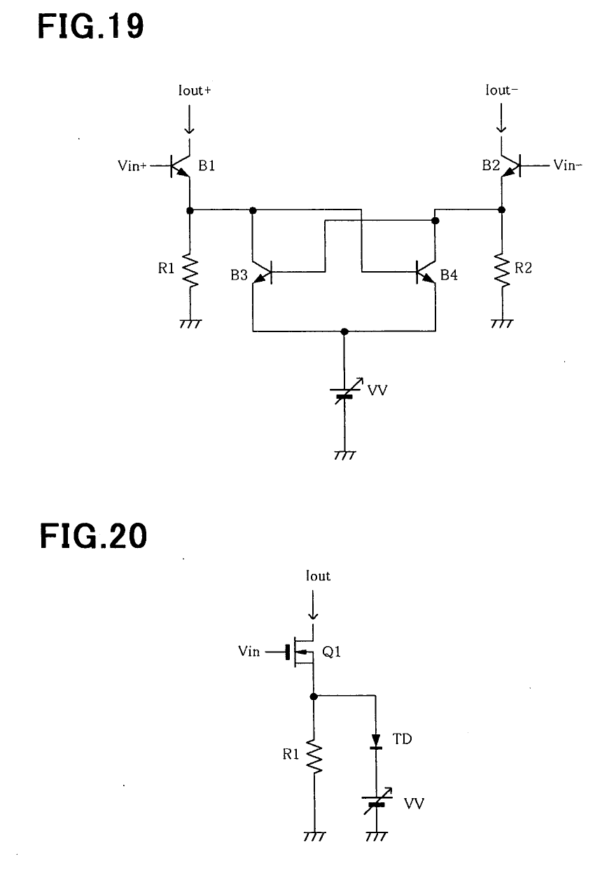

FIG. 19 is a circuit diagram of a voltage-current converting circuit in accordance with the thirteenth embodiment of the present invention.

The voltage-current converting circuit in accordance with the thirteenth embodiment includes npn-type bipolar transistors B1, B2, B3 and B4 in place of the n-type MOSFET transistors Q1, Q2, Q3 and Q4, respectively, in comparison with the voltage-current converting circuit in accordance with the fifth embodiment, illustrated in FIG. 6. The voltage-current converting circuit in accordance with the thirteenth embodiment is structurally identical with the voltage-current converting circuit in accordance with the fifth embodiment, illustrated in FIG. 6, except the above-mentioned difference. Hence, parts or elements in FIG. 19 that correspond to those of FIG. 6 have been provided with the same reference numerals.

By defining “gm” as a voltage-current conversion gain of a bipolar transistor, the voltage-current converting circuit operates in accordance with the equation (7), similarly to the voltage-current converting circuit in accordance with the fifth embodiment, illustrated in FIG. 6. It should be noted that “gm_{Q3}” in the equation (7) is replaced with “gm_{B3}” defined as gm of the bipolar transistor B3.

The voltage-current converting circuit in accordance with the thirteenth embodiment provides the same advantages as those obtained by the voltage-current converting circuit in accordance with the fifth embodiment. That is, a bipolar transistor may be used in place of a MOSFET transistor acting as an active device, in the above-mentioned first to twelfth embodiments.

### Fourteenth Embodiment

FIG. 20 is a circuit diagram of a voltage-current converting circuit in accordance with the fourteenth embodiment of the present invention.

The voltage-current converting circuit in accordance with the fourteenth embodiment includes a tunnel diode TD as a negative resistor NR, in comparison with the voltage-current converting circuit in accordance with the first embodiment, illustrated in FIG. 1.

Specifically, the negative resistor in the voltage-current converting circuit in accordance with the fourteenth embodiment is comprised of a tunnel diode TD having an input terminal electrically connected to a junction node at which a source of the n-type MOSFET transistor Q1 and the positive resistor R1 are electrically connected to each other, and an output terminal electrically connected to a later-mentioned variable voltage source VV, and a variable voltage source VV electrically connected at one end thereof to the tunnel diode TD, and at the other end grounded. The voltage-current converting circuit in accordance with the fourteenth embodiment is structurally identical with the voltage-current converting circuit in accordance with the first embodiment, illustrated in FIG. 1, except the above-mentioned negative resistor.

The variable voltage source VV is electrically connected between the tunnel diode TD and a ground. By controlling a bias voltage, a negative resistance of the negative resistor NR can be controlled.

### Fifteenth Embodiment

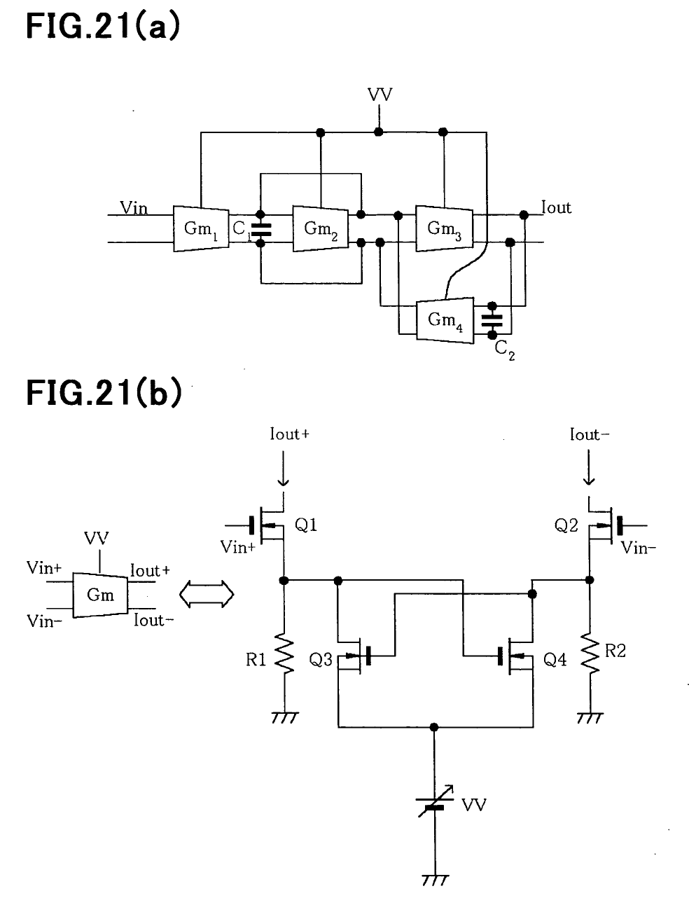

FIG. 21(a) is a circuit diagram of a filter circuit in accordance with the fifteenth embodiment of the present invention.

The filter circuit illustrated in FIG. 21(a) is a secondary low-pass filter circuit having a variable bandwidth, comprising first to fourth voltage-current converting circuits Gm₁, Gm₂, Gm₃ and Gm₄, and first and second capacity devices C₁ and C₂.

Each of two output terminals of the first voltage-current converting circuits Gm₁ is electrically connected to each of two input terminals of the second voltage-current converting circuits Gm₂, and each of two output terminals of the second voltage-current converting circuits Gm₂ is electrically connected to both each of two input terminals of the third voltage-current converting circuits Gm₃ and each of two input terminals of the fourth voltage-current converting circuits Gm₄. Each of two output terminals of the third voltage-current converting circuits Gm₃ is electrically connected to each of two output terminals of the fourth voltage-current converting circuits Gm₄. That is, the third voltage-current converting circuits Gm₃ and the fourth voltage-current converting circuits Gm₄ are electrically connected in parallel with each other. Each of two input terminals of the second voltage-current converting circuits Gm₂ is electrically connected to each of two output terminals thereof.

A variable voltage source VV is electrically connected to each of the first to fourth voltage-current converting circuits Gm₁, Gm₂, Gm₃ and Gm₄.

The first capacity device C₁ is electrically connected between the two output terminals of the first voltage-current converting circuits Gm₁, and the second capacity device C₂ is electrically connected between the two output terminals of the fourth voltage-current converting circuits Gm₄.

FIG. 21(b) is a circuit diagram of the first to fourth voltage-current converting circuits Gm₁, Gm₂, Gm₃ and Gm₄.

As is obvious in view of FIG. 21(b), each of the first to fourth voltage-current converting circuits Gm₁, Gm₂, Gm₃ and Gm₄ is comprised of the voltage-current converting circuit in accordance with the fifth embodiment, illustrated in FIG. 6.

A transfer function of the filter circuit in accordance with the fifteenth embodiment is expressed with the equation (8).

$$F ( s ) = \frac{\frac{{gm}_{1} \cdot {gm}_{3}}{{C}_{1} \cdot {C}_{2}}}{{s}^{2} + \frac{{gm}_{2}}{{C}_{1}} s + \frac{{gm}_{3} \cdot {gm}_{4}}{{C}_{1} \cdot {C}_{2}}} \qquad ( 8 )$$

If total gains of the first to fourth voltage-current converting circuits Gm₁, Gm₂, Gm₃ and Gm₄ are multiplied by A by controlling a voltage provided from the variable voltage source VV, the transfer function is expressed with the following equation.

$$\begin{matrix}\frac{\frac{A \cdot {gm}_{1} \cdot A \cdot {gm}_{3}}{{C}_{1} \cdot {C}_{2}}}{{s}^{2} + \frac{A \cdot {gm}_{2}}{{C}_{1}} s + \frac{A \cdot {gm}_{3} \cdot A \cdot {gm}_{4}}{{C}_{1} \cdot {C}_{2}}} = \frac{\frac{{gm}_{1} \cdot {gm}_{3}}{{C}_{1} \cdot {C}_{2}}}{{( \frac{s}{A} )}^{2} + \frac{{gm}_{2}}{{C}_{1}} \cdot \frac{s}{A} + \frac{{gm}_{3} \cdot {gm}_{4}}{{C}_{1} \cdot {C}_{2}}} \\ = F ( \frac{s}{A} )\end{matrix}$$

The latter transfer function is scaled A times relative to the former transfer function with respect to a frequency.

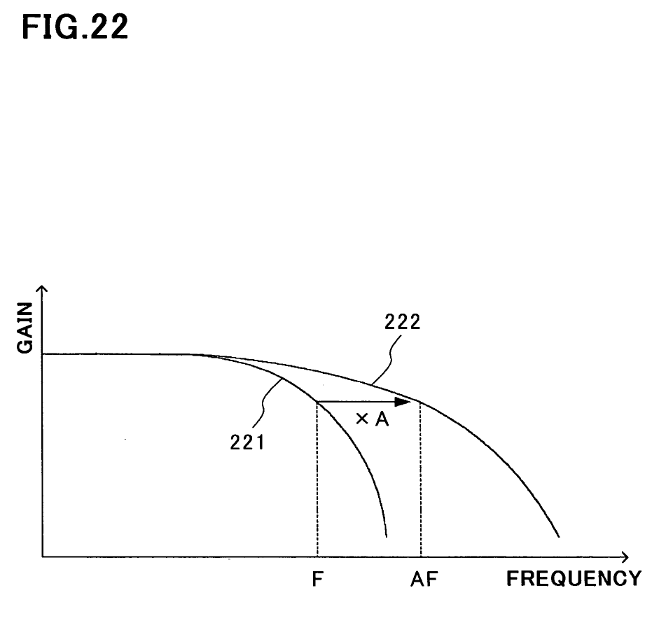

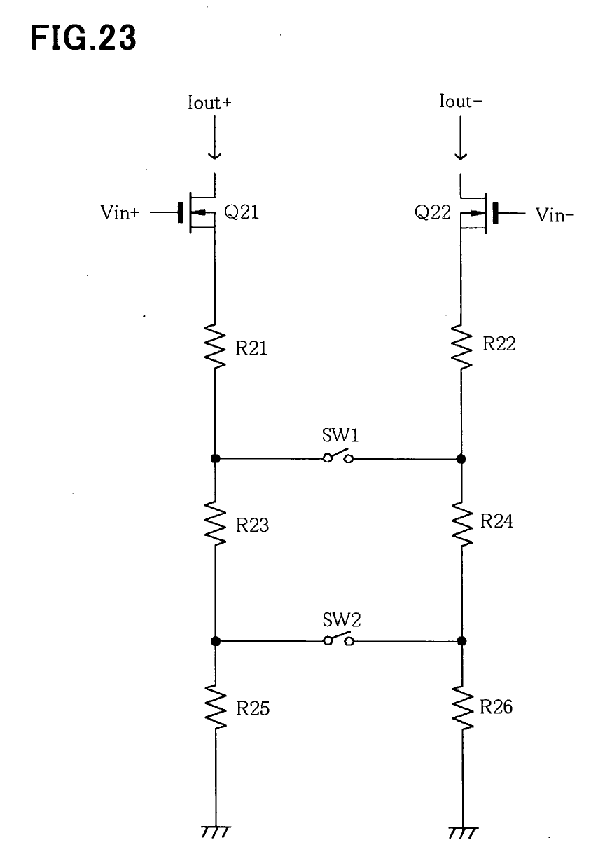

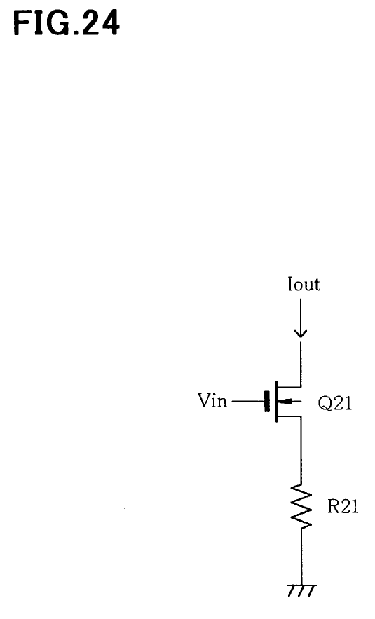

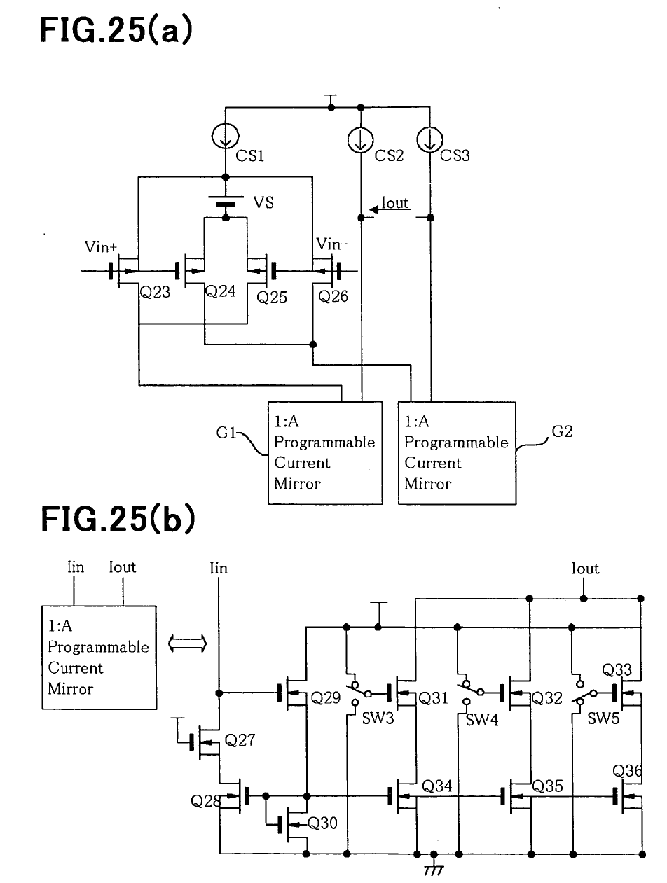

FIG. 22 is a graph showing a relation between a gain and a frequency in the filter circuit in accordance with the fifteenth embodiment. The solid line 221 shows the relation obtained by the transfer function expressed with the equation (8), and the solid line 222 shows the relation obtained by the latter transfer function.

As illustrated in FIG. 22, with respect to a certain frequency F, a bandwidth in the latter transfer function is amplified A times relative to a bandwidth in the transfer function expressed with the equation (8).

Though each of the first to fourth voltage-current converting circuits Gm₁, Gm₂, Gm₃ and Gm₄ constituting the filter circuit in accordance with the fifteenth embodiment is comprised of the voltage-current converting circuit in accordance with the fifth embodiment, illustrated in FIG. 6, the voltage-current converting circuits in accordance with the other embodiments may be used.

Furthermore, it is not always necessary for the first to fourth voltage-current converting circuits Gm₁, Gm₂, Gm₃ and Gm₄ to be comprised of the same voltage-current converting circuit. The first to fourth voltage-current converting circuits Gm₁, Gm₂, Gm₃ and Gm₄ may be comprised of different voltage-current converting circuits from one another. For instance, the first voltage-current converting circuits Gm₁ may be comprised of the voltage-current converting circuit in accordance with the fifth embodiment, the second voltage-current converting circuits Gm₂ may be comprised of the voltage-current converting circuit in accordance with the sixth embodiment, the third voltage-current converting circuits Gm₃ may be comprised of the voltage-current converting circuit in accordance with the seventh embodiment, and the fourth voltage-current converting circuits Gm₄ may be comprised of the voltage-current converting circuit in accordance with the eighth embodiment.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

For instance, one of positive and negative resistors is comprised of a resistor having a variable resistance, and the other is comprised of a resistor having a fixed resistance in the above-mentioned embodiments. Instead, both of positive and negative resistors may be comprised of a resistor having a variable resistance.

### INDUSTRIAL APPLICABILITY

As having been explained so far, the voltage-current converting circuit in accordance with the present invention is comprised of an active device carrying out voltage-current conversion, and a variable-resistance circuit electrically connected in series to the active device, and including a negative resistance device. Hence, the voltage-current converting circuit makes it possible to vary a gain without necessity of using a switching circuit by applying a control voltage to a single control terminal (a control terminal of the active device).

Furthermore, the present invention makes it possible to vary a gain with a circuit having a simple structure and including a small number of devices, ensuring reduction in a chip size, and further ensuring proposal of a small-sized voltage-current converting circuit in a low price. The voltage-current converting circuit in accordance with the present invention accomplishes a multi-mode channel-selecting filter adapted to a plurality of communication processes, in a small chip-area, contributing to accomplishment of a multi-mode receiver having a small chip-area.

1. A voltage-current converting circuit which outputs a current in accordance with a voltage input thereto, comprising:
an active device having an input terminal, an output terminal, and a grounded terminal, and carrying out voltage-current conversion; and
a resistor circuit electrically connected in series to said active device through said grounded terminal of said active device, and controlling a conversion gain of said active device,
said resistor circuit having a variable resistance, and including a negative resistance device.

2. The voltage-current converting circuit as set forth in claim 1, wherein said active device is comprised of a pair of active devices each operating differentially with each other, and each having an input terminal, an output terminal, and a grounded terminal, and carrying out voltage-current conversion,
said resistor circuit is comprised of a pair of resistor circuits each electrically connected in series to each of said active devices through said grounded terminal of each of said active devices, and each controlling a conversion gain of each of said active devices,
each of said resistor circuits having a variable resistance, and including a negative resistance device.

3. The voltage-current converting circuit as set forth in claim 1, wherein said negative resistance device has a variable resistance.

4. The voltage-current converting circuit as set forth in claim 1, wherein said resistor circuit or each of said resistor circuits is comprised of:
one or a plurality of resistance device(s) electrically connected in series to said active device; and
a negative resistance device electrically connected in parallel with at least one of said resistance device(s).

5. The voltage-current converting circuit as set forth in claim 1, wherein said resistor circuit or each of said resistor circuits is comprised of a first circuit comprised of a resistance device and a negative resistance device electrically connected in series to each other,
said first circuit being electrically connected in series to said active device.

6. The voltage-current converting circuit as set forth claim 1, wherein said resistor circuit or each of said resistor circuits is comprised of a first resistance device electrically connected in series to said active device, and a second circuit electrically connected in parallel with said first resistance device,
said second circuit being comprised of a negative resistance device, and a second resistance device electrically connected in series to said negative resistance device.

7. The voltage-current converting circuit as set forth in claim 2, wherein said negative resistance device of said pair of resistance circuits is comprised of a pair of active devices electrically connected in cross to each other and operating differentially with each other, and each receiving, as an input signal, a node signal either at a connection node at which said active device and said resistor circuit are electrically connected to each other or at any connection node in said resistor circuit.

8. The voltage-current converting circuit as set forth in claim 1, wherein said negative resistance device is comprised of a field effect transistor or a bipolar transistor.

9. The voltage-current converting circuit as set forth in claim 8, wherein a resistance of said negative resistance device is controlled by controlling either a source voltage or an emitter voltage of said field effect transistor or bipolar transistor.

10. The voltage-current converting circuit as set forth in claim 9, further comprising a voltage-providing circuit electrically connected between a reference voltage point and either a source or an emitter of said field effect transistor or bipolar transistor, and wherein a resistance of said negative resistance device is controlled by controlling a voltage provided by said voltage-providing circuit.

11. The voltage-current converting circuit as set forth in claim 10, wherein said voltage-providing circuit is comprised of:
an operational amplifier having a first input terminal, a second input terminal, and an output terminal; and
an active device,
wherein a voltage-control signal is input to said first input signal of said operational amplifier,
an input terminal of said active device is electrically connected to said output terminal of said operational amplifier, and an output terminal of said active device is electrically connected to said second input terminal of said operational amplifier.

12. The voltage-current converting circuit as set forth in claim 9, wherein said negative resistance device is comprised of a pair of field effect transistors or bipolar transistors operating differentially with each other,
wherein sources or emitters of said field effect transistors or bipolar transistors are electrically connected to each other.

13. The voltage-current converting circuit as set forth in claim 1, further comprising a voltage-controller electrically connected to a connection node at which said active device and said resistor circuit are electrically connected to each other, for controlling a voltage of said connection node.

14. The voltage-current converting circuit as set forth in claim 13, wherein said voltage-controller is comprised of an active device electrically connected between a reference voltage and said connection node, and having an input terminal to which a bias signal is input.

15. The voltage-current converting circuit as set forth in claim 13, wherein said voltage-controller compensates for voltage fluctuation caused at said connection node by variance of a resistance of said negative resistance device.

16. The voltage-current converting circuit as set forth in claim 1, wherein said resistor circuit includes a variable resistor having a positive resistance.

17. The voltage-current converting circuit as set forth in claim 16, wherein said variable resistor is comprised of an active device.

18. The voltage-current converting circuit as set forth in claim 1, wherein said active device is comprised of a field effect transistor or a bipolar transistor.

19. The voltage-current converting circuit as set forth in claim 1, wherein said active device carrying out voltage-current conversion and said active device comprising said negative resistance device are comprised of the same transistors having electrical conductivities different from each other.

20. A filtering circuit including a combination circuit comprised of the voltage-current converting circuit, and a capacity device, wherein a pass band is controlled by varying a gain of said voltage-current converting circuit,
said voltage-current converting circuit comprising:
an active device having an input terminal, an output terminal, and a grounded terminal, and carrying out voltage-current conversion; and
a resistor circuit electrically connected in series to said active device through said grounded terminal of said active device, and controlling a conversion gain of said active device, said resistor circuit having a variable resistance, and including a negative resistance device.
